(19) United States
(12) Patent Application Publication
(10) Pub. No.: US 2010/0261071 A1
(43) Pub. Date: Oct. 14, 2010

(54) METALLIZED FIBERS FOR ELECTROCHEMICAL ENERGY STORAGE

(75) Inventors: Sergey D. Lopatin, Morgan Hill, CA (US); Robert Z. Bachrach, Burlingame, CA (US); Liang-Yuh Chen, San Jose, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/759,404

(22) Filed: Apr. 13, 2010

Related U.S. Application Data
(60) Provisional application No. 61/168,886, filed on Apr. 13, 2009.
(60) Provisional application No. 61/180,607, filed on May 22, 2009.

(51) Int. Cl. H01M 6/02; H01M 4/02; H01M 6/00; D01H 13/30; C25D 17/00

(52) U.S. Cl. 429/345; 429/209; 29/623.5; 118/641; 57/295; 204/242

(57) ABSTRACT

A cost effective method and apparatus are provided for forming metallized fibers and depositing multilayer films thereon to form thin film electrochemical energy storage devices. In one embodiment, a fibrous substrate is formed using a fiber spinning process and the fibrous substrate is plated with a copper layer using wet deposition. Multiple material layers are then deposited onto the copper layer to form a lithium-ion battery fiber.

### CROSS-REFERENCE TO RELATED APPLICATIONS

This application claims benefit of U.S. provisional patent application Ser. No. 61/168,886 (Attorney Docket No. 12923L), filed Apr. 13, 2009, and U.S. provisional patent application No. 61/180,607, filed May 22, 2009 (Attorney Docket No. 12924L), both of which are herein incorporated by reference in their entirety. This application is related to U.S. patent application Ser. No. __/______, filed Apr. 13, 2010 (Attorney Docket No. 12923).

### BACKGROUND OF THE INVENTION

1. Field of the Invention

Embodiments of the present invention generally relate to a method and apparatus for forming metallized fibers which may be used to form electrochemical energy storage devices. More specifically, embodiments of the invention relate to a method and apparatus for forming metallized fibers and depositing multilayer films thereon to form thin film electrochemical energy storage devices.

2. Description of the Related Art

Multifunctional composite materials which may function as power sources have attracted great interest due to the wide range of potential applications of such materials. The multifunctional composite materials may be formed by depositing multilayer films on substrates having unconventional geometries to form thin film electrochemical energy storage devices (e.g., batteries, supercapacitors) or energy conversion devices (e.g., fuel cells, photovoltaic cells) on the substrates. The substrates having unconventional geometries may include fibers, fabrics, ribbons, rods, or other structures which may be used as structural elements in various applications. For example, fibers with thin film electrochemical energy storage devices formed thereon may be used to form fabrics or fiber reinforced composites which may also function as power sources. The multifunctional composite materials may thus function as structural materials as well as power sources, and such combined functionality may provide, for example, savings in space, weight, and cost for applications which require power supplies.

One example of a multifunctional composite material which can function as a power source is a battery fiber. FIG. 1A is a cross-sectional perspective view of a prior art battery fiber 100. The battery fiber 100 comprises a fibrous substrate 102 and multiple layers of solid material thereon which form a thin film battery. For clarity, the battery fiber 100 is not drawn to scale and the layer thicknesses relative to the thickness of the fibrous substrate 102 are exaggerated. The materials of each layer may be suitably selected to form different types of batteries, such as lithium-based batteries or batteries with non-lithium chemistries, for example. The fibrous substrate 102 has an approximately circular cross-section which is perpendicular to a centrally located fiber axis “A” which parallels the fiber length. The fibrous substrate 102 is coated with a layer of metallic material to form a cathode current collector layer 104 which is covered with a layer of cathodic material to form a cathode layer 106. An electrolytic material is deposited onto the cathode layer 106 to form a solid electrolyte layer 108 which is covered by a layer of anodic material which forms an anode layer 110. A second layer of metallic material covers the anode layer 110 to form an anode current collector layer 112. An electrically insulative material may be deposited onto the anode current collector layer 112 to form a protective coating layer 114 which protects and seals the underlying layers of the battery fiber 100.

The battery fiber 100 may be patterned during or after its formation so that the cathode current collector layer 104 and anode current collector layer 112 are exposed at desired locations along the fiber length so that an electrical load may be coupled to the current collector layers and draw power from the battery fiber 100. Examples of battery fibers 100 are disclosed by M. Benson et al. in U.S. Patent Application Publication No. 2003/0059526 A1, filed on Apr. 1, 2002.

Multiple battery fibers 100 may be combined to form different types of structural materials which can also provide power for various applications. FIG. 1B is a perspective view of a prior art battery fiber fabric 150 comprising the battery fibers 100 shown in FIG. 1A. Multiple battery fibers 100 are woven together to form a flexible fabric which can provide power. The individual battery fibers 100 within the sheet the may be electrically coupled to each other in series or parallel depending upon the power requirements of the application. One or more battery fiber fabrics 150 may also be combined with epoxies, resins, or other matrix materials to form rigid or semi-rigid sheets or panels. In other applications, the battery fibers 100 may be combined with matrix materials to form tubes, rods, beams, or other structural composites which can function as power sources. Examples of battery fiber fabrics 150 and other composite materials containing battery fibers 100 are disclosed by J. Armstrong et al. in U.S. Patent Application Publication No. 2003/0068559 A1, filed on Sep. 11, 2002.

The range of potential applications for fibers which may function as power sources and structural materials make the cost effective production of such multifunctional fibers desirable. A cost effective method for forming metallized fibers is also desirable since a thin film electrochemical energy storage device typically includes one or more metallic current collector layers, such as the cathode current collector layer 104 and anode current collector layer 112 shown for the battery fiber 100, for example. Methods and apparatuses used in the semiconductor industry for forming thin film electrochemical energy storage devices are generally adapted for depositing materials on substrates having conventional geometries, such as wafers, panels, or other planar substrates. Thus, a cost effective method and apparatus for forming thin film electrochemical energy storage devices on fibers is desirable.

Therefore, a need exists for a cost effective method and apparatus for forming metallized fibers and depositing multilayer films thereon to form thin film electrochemical energy storage devices, such as batteries, for example.

### SUMMARY OF THE INVENTION

Embodiments of the present invention provide a cost effective method and apparatus for forming a metallized fibrous substrate and depositing multiple film layers thereon to form an electrochemical energy storage device.

In one embodiment, a metallized fiber is configured for use in an electrochemical storage device, and the metallized fiber comprises a fibrous substrate, an initiation-adhesion layer disposed over the fibrous substrate, and a metallic layer disposed on the initiation-adhesion layer.

In another embodiment, a method is provided for forming a metallized fiber used in an electrochemical storage device. The method comprises forming a fibrous substrate, forming an initiation-adhesion layer over the fibrous substrate, and depositing a metallic layer on the initiation-adhesion layer.

In one embodiment, an apparatus for forming a metallized fiber is disclosed. The apparatus comprises a primary support adapted for coupling to a portion of a fibrous substrate, a fiber forming apparatus adapted for forming a fibrous substrate, and one or more processing stations adapted for metallizing a portion of the fibrous substrate disposed between the primary support and the fiber forming apparatus, and the primary support is adapted to position a portion of the fibrous substrate in the one or more processing stations.

In another embodiment, a battery fiber comprises a metallized fiber having an anode layer, an electrolyte/separator layer disposed over the anode layer, a cathode layer disposed on the electrolyte/separator layer, and a second metallic layer disposed on the cathode layer.

In one embodiment, a method is provided for forming a battery fiber. The method comprises forming a metallized fiber having an anode layer, forming an anode layer on the anode layer, depositing an electrolyte/separator layer over the anode layer, depositing a cathode layer on the electrolyte/separator layer, and depositing a second metallic layer on the cathode layer.

In yet another embodiment, an apparatus for forming a battery fiber is provided. The apparatus comprises a primary support adapted for coupling to a portion of a metallized fiber, a metallized fiber forming apparatus adapted for forming a metallized fiber, and one or more processing stations adapted for depositing films on a portion of the metallized fiber disposed between the primary support and the metallized fiber forming apparatus, and the primary support is adapted to position a portion of the metallized fiber in the one or more processing stations.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a cross-sectional perspective view of a prior art battery fiber.

FIG. 1B is a perspective view of a prior art battery fiber fabric comprising the battery fibers shown in FIG. 1A.

FIG. 2 is a schematic cross-sectional view of a metallized fiber according to one embodiment of the invention.

FIG. 3A is a schematic cross-sectional view of a battery fiber before battery charging according to one embodiment of the invention.

FIG. 3B is a schematic cross-sectional view of the battery fiber shown in FIG. 3A after battery charging according to one embodiment described herein.

FIG. 3C is a schematic cross-sectional view of the battery fiber shown in FIG. 3B according to one embodiment described herein.

FIG. 3D is a schematic cross-sectional view of a multiple battery fiber according to one embodiment described herein.

FIG. 4 illustrates a process for forming the metallized fiber shown in FIG. 2 according to one embodiment of the invention.

FIG. 5 illustrates a process for forming the battery fiber shown in FIGS. 3A and 3B according to one embodiment of the invention.

FIG. 6A is a simplified schematic view of an apparatus for forming the metallized fiber shown in FIG. 2 according to one embodiment of the invention.

FIG. 6B is a simplified detail view of the apparatus shown in FIG. 6A according to another embodiment described herein.

FIG. 6C is a simplified schematic view of the apparatus shown in FIG. 6A according to another embodiment described herein.

FIG. 6D is a simplified schematic view of the apparatus shown in FIG. 6A according to one embodiment described herein.

FIG. 6E is a simplified schematic view of the apparatus shown in FIG. 6A according to another embodiment described herein.

FIG. 7A is a simplified schematic view of the apparatus shown in FIG. 6A which uses a wet deposition process according to another embodiment of the invention.

FIG. 7B is a simplified schematic view of a wet deposition apparatus according to one embodiment described herein.

FIG. 8A is a simplified schematic view of an apparatus for forming the battery fiber shown in FIGS. 3A and 3B according to one embodiment of the invention.

FIG. 8B is a simplified schematic view of a deposition apparatus according to one embodiment of the invention.

To facilitate understanding, identical reference numerals have been used, where possible, to designate identical elements that are common to the figures. It is contemplated that features of one embodiment may be incorporated in other embodiments without further recitation.

### DETAILED DESCRIPTION

The present invention generally provides a cost effective method and apparatus for forming metallized fibers and depositing multilayer films thereon to form electrochemical energy storage devices. In one embodiment, a fibrous substrate is formed using a fiber forming process and the fibrous substrate is plated with a copper layer using a wet deposition process. Multiple material layers are then deposited onto the copper layer to form a lithium-based battery fiber.

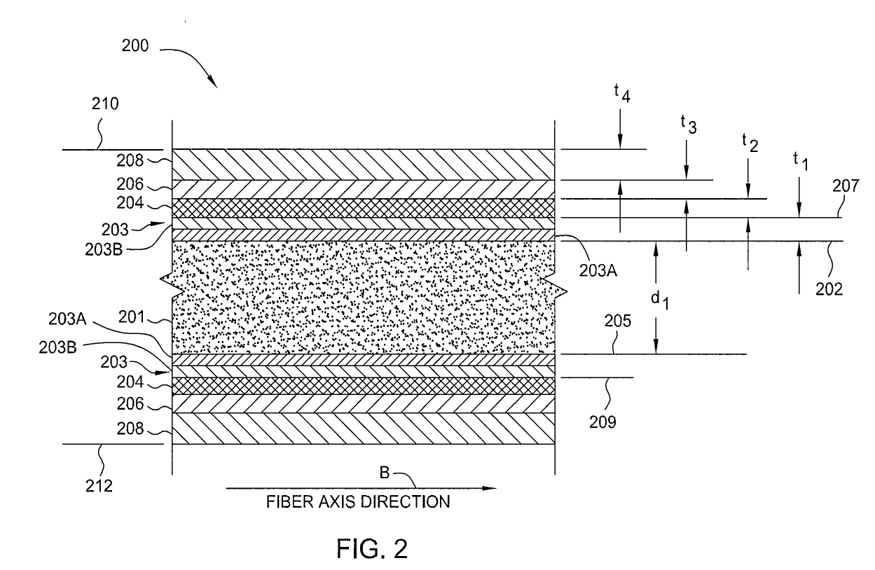

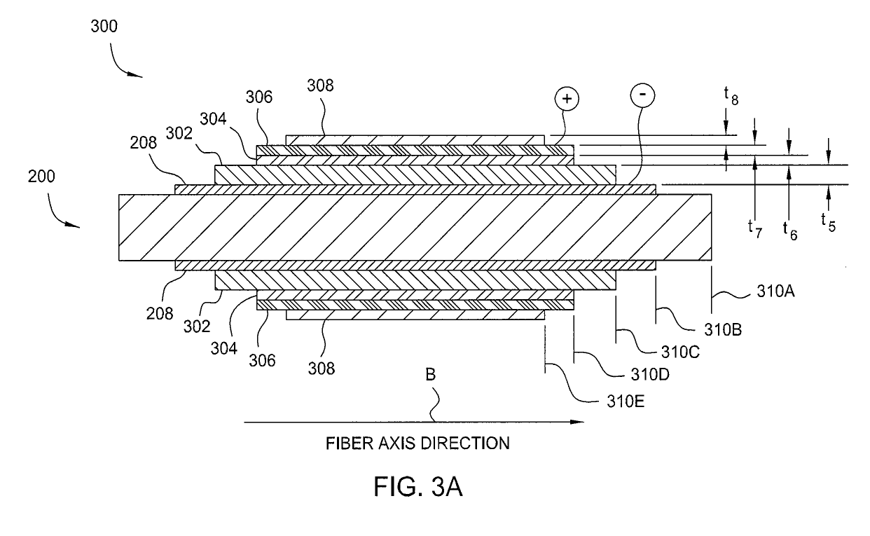

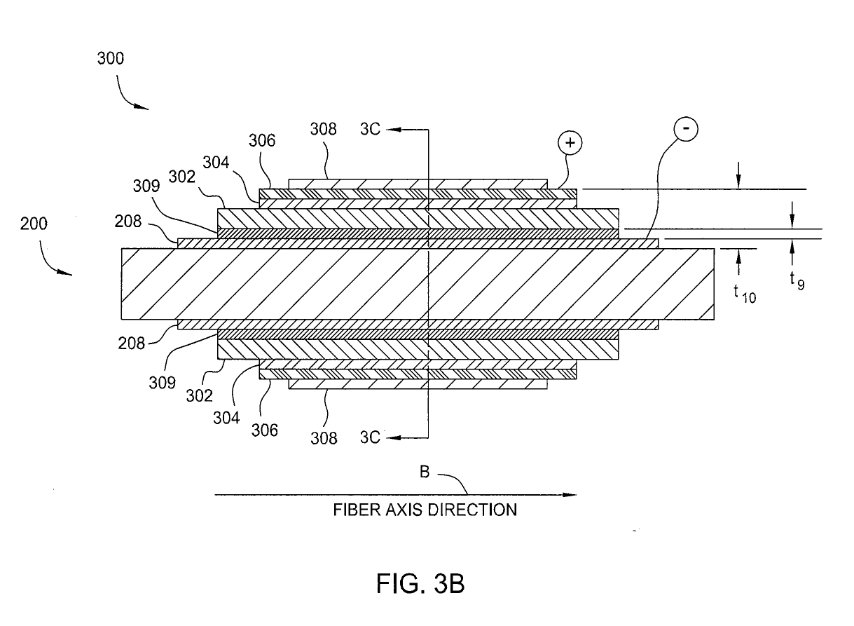

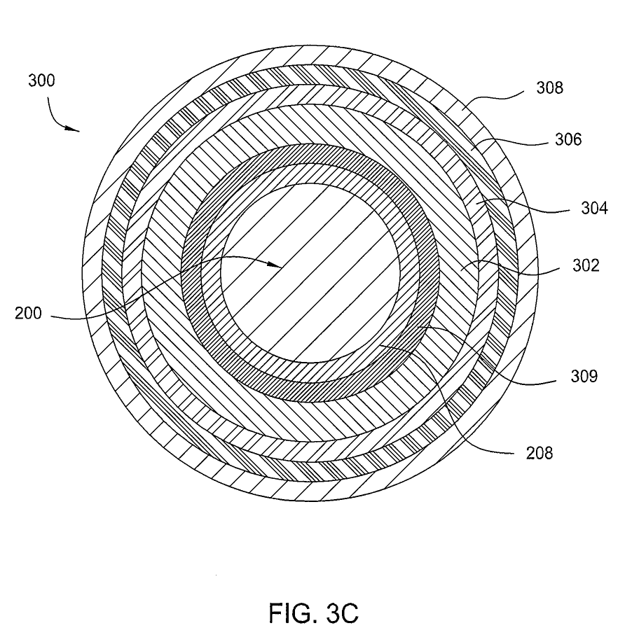

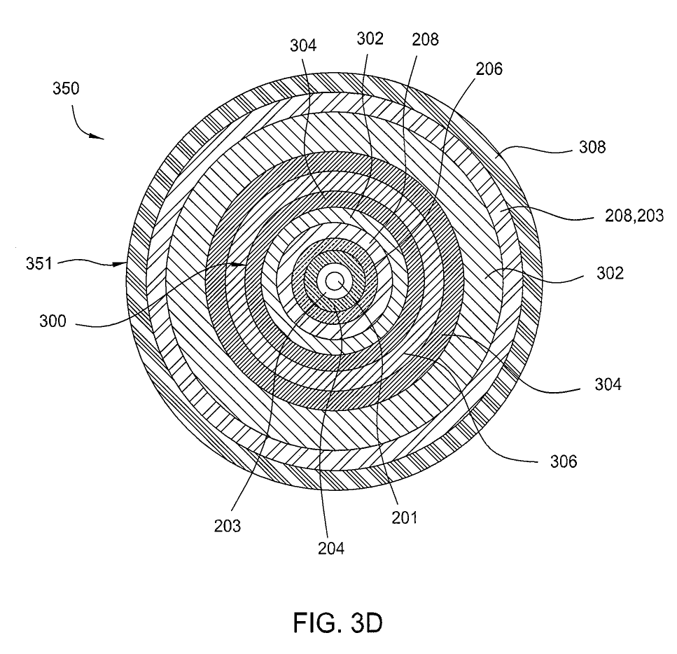

FIG. 2 is a schematic cross-sectional view of a metallized fiber 200 according to one embodiment of the invention. The metallized fiber 200 comprises a fibrous substrate 201 having a length which extends in a direction parallel to a fiber axis direction “B.” The fibrous substrate 201 has a cross-section which is perpendicular to the fiber axis direction “B” and the cross-section may be approximately circular (see FIG. 3C) in shape. The fibrous substrate 201 may have cross-sectional shapes which include but are not limited to round, oval, square, rectangular, hexagonal, octagonal, polygonal, lobed, and combinations thereof. Fibrous substrates 201 having polygonal cross-sections may be described as fibers having multiple planar surfaces or facets. As defined herein, fibrous substrates 201 having “flat” cross-sections may include ribbons or ribbon-like substrates.

The fibrous substrate 201 may comprise materials which include but are not limited to carbon, carbon-containing compounds, carbides, carbon nanotubes, carbon nanofibers, silicas, aluminum oxides, lead zirconium titanate, glasses, ceramics, polymers, aramid, aromatic polyamides, polyethylenes, polyamides, nylons, acrylics, rayons, cellulosics, metals, metal alloys, semiconductors, superconductors, optical fibers, wires, or combinations thereof. The fibrous substrate 201 may also comprise a strand of fibers. In one embodiment, the fibrous substrate 201 comprises carbon or aluminum oxide.

The fibrous substrate 201 comprises a first surface 202 and a second surface 205. The first surface 202 and the second surface 205 may comprise two separate surfaces (e.g., a top surface and a bottom surface of a faceted fiber or ribbon-like fiber) of the fibrous substrate 201. In another embodiment, the first surface 202 and the second surface 205 comprise a single outer surface (e.g., cylindrical surface) of the fibrous substrate 201.

On each of the first surface 202 and the second surface 205, the metallized fiber 200 further comprises a supplementary layer 203, a nanofilament layer 204 formed on the supplementary layer 203, an initiation-adhesion layer 206 formed over the nanofilament layer 204, and a metallic layer 208 formed on the initiation-adhesion layer 206. In another embodiment, only the first surface 202 may be covered with the aforementioned layers. A first metallic surface 210 and a second metallic surface 212 of the metallic layers 208 may receive additional material layers thereon to form an energy storage device (see FIG. 3A) or an energy conversion device.

The supplementary layer 203 comprises one or more treatment layers and/or layers of deposited material which may help facilitate or control the deposition of other layers. The one or more supplementary layers 203 may also include materials which are used to alter or modify the properties of the metallized fiber 200. The metallized fiber 200 may comprise one or more supplementary layers 203, and the supplementary layer(s) 203 may be disposed between other layers of the metallized fiber 200. In one embodiment, the supplementary layer 203 is part of the surface of the fibrous substrate 201. In another embodiment, the supplementary layer 203 is formed over the surface of the fibrous substrate 201. In another embodiment the metallized fiber 200 does not include any supplementary layers 203.

In one embodiment, the supplementary layer 203 comprises a first current collecting layer 203A that is formed on the fibrous substrate material. The current collecting layer 203A may include a relatively thin electrically conductive material disposed on the host fibrous substrate. The current collecting layer 203A may comprise one or more conductive materials, such as a metal, plastic, graphite, polymers, carbon-containing polymer, composite, or other suitable materials. Examples of metals that the current collector layer 203A may be formed from include copper (Cu), zinc (Zn), nickel (Ni), cobalt (Co), palladium (Pd), platinum (Pt), tin (Sn), ruthenium (Ru), stainless steel, alloys thereof, and combinations thereof, which are deposited on the host fibrous substrate using an evaporation, physical vapor deposition (PVD), chemical vapor deposition (CVD), or other similar processes. The thickness of the current collecting layer 203A may range from a few nanometers to a few tens of micrometers.

In one embodiment, the supplementary layer 203 comprises one or more treatment layers, such as a second layer 203B, which may include layers of deposited material, and/or features which help facilitate or control the formation of graphitic nanofilaments (i.e., carbon nanotubes and/or carbon nanofibers). In one embodiment, the supplementary layer 203 comprises one or more layers of catalytic materials which facilitate the growth of graphitic nanofilaments. The catalytic materials may include but are not limited to iron, cobalt, nickel, copper, silver, magnesium, ruthenium, rhodium, iridium, platinum, palladium, molybdenum, tungsten, chromium and alloys, oxides, and combinations thereof. Combinations or mixtures of catalyst materials which may be used include but are not limited to iron-nickel, iron-molybdenum, iron-cobalt, cobalt-nickel, and cobalt-molybdenum. Preferred catalysts include iron, cobalt, nickel and alloys thereof. In one embodiment, the supplementary layer 203 comprises buffer materials which prevent the catalytic materials from reacting or alloying with the fibrous substrate 201 at the nanofilament growth temperature. The buffer materials may include titanium nitride or silicon dioxide, for example.

In one embodiment, the supplementary layer 203 comprises supplementary materials and/or features which inhibit or prevent the growth of graphitic nanofilaments, and such materials or features may be patterned on the fibrous substrate 201. In one embodiment, the supplementary layer 203 comprises two or more layers wherein some layers facilitate and promote graphitic nanofilament growth and other layers inhibit or prevent nanofilament growth.

In one embodiment, the supplementary layer 203 comprises a treatment layer, such as an oxide layer, for example. In one example, the oxide layer may comprise various types of oxides which may be formed by exposing a first surface 207 and a second surface 209 of the supplementary layer 203 to air or by oxidizing treatments of said surfaces.

In one embodiment, the supplementary layer 203 comprises oriented pores or holes which may help align graphitic nanofilaments in the direction in which the pores are oriented. The graphitic nanofilaments may form in the pores and grow substantially parallel to the walls of the pores. The diameters of the pores may be nanometer-scale in size. In one embodiment, the pore walls may be oriented substantially perpendicular to the first surface 202 and/or the second surface 205.

In another embodiment, the supplementary layer 203 comprises supplementary materials which may enhance or modify properties of the metallized fiber 200, and such materials may include forms of carbon, such as diamond, diamond-like carbon (DLC), and fluorinated carbon, or other materials such as silicates, metal oxides, metal fluorides, ceramics, and polymers, for example. In one embodiment, the supplementary layer 203 is disposed between the nanofilament layer 204 and the initiation-adhesion layer 206. In one embodiment, the initiation-adhesion layer 206 and/or metallic layer 208 comprise supplementary materials which include but are not limited to diamond, diamond-like carbon (DLC), fluorinated carbon, silicates, metal oxides, metal fluorides, ceramics, and polymers.

Referring to FIG. 2, the nanofilament layer 204 comprises graphitic nanofilaments which are formed over the fibrous substrate 201. The graphitic nanofilaments comprise carbon nanotubes and/or carbon nanofibers. The carbon nanotubes may include single-walled and/or multi-walled carbon nanotubes, and the carbon nanofibers may include herringbone, platelet, ribbon, stacked-cone, and/or other carbon nanofiber types known in the art. The nanofilament layer 204 may also comprise materials (e.g., metals) which are intercalated with the graphitic nanofilaments. In one embodiment, nanofilament layers 204 are formed on the first surface 207 and the second surface 209 of the supplementary layers 203. In another embodiment, the nanofilament layer 204 is formed on the fibrous substrate 201 with no intervening supplementary layer 203. In yet another embodiment, the metallized fiber 200 does not include the nanofilament layer 204.

The initiation-adhesion layer 206 comprises one or more layers of materials which facilitate the deposition and adhesion of the metallic layer 208. The initiation-adhesion layer 206 may comprise a nucleation, seed and/or initiation layer which prepares the fibrous substrate 201 for the deposition of a metallic material. The initiation-adhesion layer 206 may be formed on a nanofilament layer 204, a supplementary layer 203, or directly on the fibrous substrate 201.

In one embodiment, the initiation-adhesion layer 206 comprises a seed or nucleation layer which comprises materials which may include but are not limited to copper, tin, aluminum, bismuth, antimony, nickel, titanium, vanadium, chromium, manganese, iron, cobalt, silver, gold, zinc, and alloys and oxides thereof. In another embodiment, the initiation-adhesion layer 206 comprises an initiation layer which comprises one or more catalytic materials which may initiate an electroless plating process. The catalytic materials may be deposited using sensitizing and activating solutions. In one embodiment, the initiation-adhesion layer 206 comprises metals or metal alloys. In one embodiment, the initiation-adhesion layer 206 comprises catalytic materials which include but are not limited to palladium, tin, platinum, gold, rhodium, ruthenium, magnesium, osmium, iridium, iron, copper, cobalt, lead, mercury, nickel, aluminum, titanium, and carbon. In one embodiment, the initiation-adhesion layer 206 comprises aminopropyltriethoxysilane (APTS) and palladium (Pd). In another embodiment, the initiation-adhesion layer 206 comprises tin (Sn) and palladium. In one embodiment, the initiation-adhesion layer 206 comprises copper (Cu), copper alloy, or nickel (Ni).

The metallic layer 208 comprises one or more layers of metal or metal alloy. The metallic layer 208 may comprise materials which include but are not limited to copper, chromium, tin, aluminum, bismuth, antimony, nickel, titanium, vanadium, manganese, iron, cobalt, silver, gold, zinc, magnesium, molybdenum, platinum, lead, and alloys and oxides thereof. In one embodiment, the metallic layer 208 comprises copper or copper alloy. In one embodiment, the initiation-adhesion layer 206 and metallic layer 208 may be made sufficiently thin and/or porous to increase the exposed surface area and allow the movement of ions in the battery's electrolyte (e.g., lithium, sodium, potassium) through portions of each layer.

Referring to FIG. 2, the fibrous substrate 201 has a thickness or diameter “d₁” which may have a wide range of values depending upon the application for the metallized fiber 200. In one embodiment, the diameter “d₁” may range from a few micrometers to several centimeters, or more. In one embodiment, the supplementary layer 203 has a thickness “t₁” which may range from a few nanometers to a few tens of micrometers. The nanofilament layer 204 has a thickness “t₂” which can be up to several tens of micrometers or higher. The initiation-adhesion layer 206 has a thickness “t₃” and the metallic layer 208 has a thickness “t₄.” In one embodiment, each thickness “t₃” and “t₄” ranges from about 0.01 micrometers to about 25 micrometers. In another embodiment, each thickness “t₃” and “t₄” ranges from a few angstroms to a few micrometers. In one embodiment, the initiation-adhesion layer 206 comprises a seed layer and has a thickness “t₃” which ranges from about 10 angstroms to about 2,500 angstroms.

The metallized fiber 200 illustrated in FIG. 2, and described herein, may be used as a substrate for forming a thin film electrochemical energy storage device, and the metallized fiber 200 may function as an electrode for the device. As defined herein, an “electrode” refers to a region of an electrochemical energy storage device that is adapted to transfer electrical energy between an external load and other portions of the electrochemical storage device, which may include a current collector and/or the active materials (e.g., anodic or cathodic materials) formed thereon. The nanofilament layer 204 may be added to the metallized fiber 200 to increase the surface area of the metallic layer 208, which may function as a current collector, and the larger surface area may provide improved charge storage capabilities for the electrochemical energy storage device.

FIG. 3A is a schematic cross-sectional view of a battery fiber 300 before battery charging according to one embodiment of the invention. The battery fiber 300 comprises the metallized fiber 200 having multiple material layers formed thereon to form a solid state rechargeable thin film battery. In one embodiment, the battery fiber 300 comprises a lithium ion battery. The metallized fiber 200 extends lengthwise in a direction parallel to the fiber axis direction “B”, and, for clarity, only the metallic layer 208 of the metallized fiber 200 is shown. The metallized fiber 200 comprises one of two electrodes or current collectors of the battery fiber 300. In one embodiment, the metallic layer 208 comprises an anode current collector for the battery fiber 300.

The battery fiber 300 further comprises an electrolyte/separator layer 302 which is formed over the metallic layer 208, a cathode layer 304 formed on the electrolyte/separator layer 302, a second metallic layer 306 formed on the cathode layer 304, and a protective coating layer 308 which covers the second metallic layer 306. In another embodiment, the protective coating layer 308 is omitted.

The electrolyte/separator layer 302 comprises one or more layers of a solid state electrolytic material which can conduct ions of an active metal, such as an alkali metal (e.g., lithium, sodium), an alkaline earth metal, or a transition metal, for example. In one embodiment, the active metal is lithium. The electrolytic material may comprise a glass, ceramic, polymer, or combinations thereof, for example. In one embodiment, the electrolytic material comprises one or more materials which include but are not limited to lithium phosphorous oxynitride (LiPON), lithium silicon carbon oxynitride, lithium silicon niobium oxynitride, lithium silicon tantalum oxynitride, lithium silicon tungsten oxynitride, oxynitride-based electrolytes, lithium phosphate glasses, lithium oxide glasses, lithium silicate glasses, lithium borosilicate glasses, sodium borosilicate glasses, lithium-containing sulfide glasses, oxysulfide-based electrolytes, lithium-containing glass electrolytes, lithium-containing ceramic electrolytes, lithium-containing solid polymer electrolytes, solid polymer electrolytes, or combinations thereof. In one embodiment, the electrolyte/separator layer 302 comprises lithium phosphorous oxynitride (LiPON). As used herein, LiPON refers generally to lithium phosphorous oxynitride materials. One such example is Li₃PO₄N, and other examples may incorporate higher ratios of nitrogen to increase lithium ion mobility through the electrolyte. It is believed that the higher ratios of nitrogen can also be used to enhance dielectric properties of the formed, which are needed to enhance the layer's ability to act as a separator between the anode and cathode portions of the formed device.

In another embodiment, the electrolyte/separator layer 302 comprises a solid electrolyte/separator having the formula LiₓSi_{y}M_{z}OᵥN_{w} where 0.3≦x≦0.46, 0.05≦y≦0.15, 0.016≦z<0.05, 0.05≦v<0.42, 0<w≦0.029, and M is at least one selected from the group consisting of niobium (Nb), tantalum (Ta), and tungsten (W). A method of forming a solid electrolyte is disclosed by Park et al. in U.S. Pat. No. 7,220,517.

The cathode layer 304 comprises one or more layers of cathodic materials which may include but are not limited to lithium cobalt oxides (LiCoO), including LiCoO₂, lithium manganese oxides (LiMnO), including Li₂Mn₂O₄, LiMn₂O₄, and LiMnO₂, lithium titanium oxides, vanadium oxides, including V₂O₅, lithium vanadium oxides, including LiVO₂, and Li₂V₂O₅, lithium nickel oxides, including LiNiO₂, LiNiMnCo, lithium iron phosphate, including LiFePO₄, silver vanadium oxides, titanium sulfides, manganese oxides, carbon, graphite, carbon fibers, polymers, polytetrafluoroethylene (PTFE), polyethelyne, and polypropylene. In one embodiment, the cathode layer 304 comprises lithium cobalt oxides (LiCoO) or lithium manganese oxides (LiMnO).

In one embodiment, the battery fiber 300 includes an air cathode. The air cathode may comprise the cathode layer 304, the second metallic layer 306, and the protective coating layer 308. The air cathode may also include additional material layers formed on the protective coating layer 308. In one embodiment, the cathode layer 304 may comprise mixtures of carbon (e.g., graphite, carbon fibers or particles), polymers, catalyst materials, or other materials which form a porous carbon layer permeable to oxygen. The catalyst materials may include but are not limited to manganese (Mn), cobalt (Co), ruthenium (Ru), platinum (Pt), and silver (Ag). The catalyst materials may enhance oxygen reduction and increase the specific capacity of the battery fiber 300. The second metallic layer 306 may comprise a metallic mesh, metallic strips, or a porous metallic film which is permeable to oxygen but functions as a current collector. A metallic mesh or strip may be patterned from a thin metal film, or a porous metallic film may be deposited by adjusting various deposition parameters. The protective coating layer 308 comprises an oxygen permeable membrane which acts as a moisture barrier. The protective coating layer 308 may comprise a polymer, such as polytetrafluoroethylene (PTFE), for example. Additional porous carbon layers may be deposited over the protective coating layer 308.

Referring to FIG. 3A, the second metallic layer 306 comprises one or more layers of metal or metal alloy which form the second electrode or current collector for the battery fiber 300. In one embodiment, the second metallic layer 306 comprises a cathode current collector. The plus sign “+” and minus sign “−” indicate that the cathode current collector functions as a positive electrode and the anode current collector functions as a negative electrode.

The metallic materials used for the second metallic layer 306 may be identical to or different than the materials used to form the metallic layer 208. The second metallic layer 306 may comprise materials which include but are not limited to copper, chromium, tin, aluminum, bismuth, antimony, nickel, titanium, vanadium, lithium, manganese, iron, cobalt, silver, gold, zinc, magnesium, molybdenum, platinum, lead, and alloys and oxides thereof. In one embodiment, the second metallic layer 306 comprises copper, copper alloy, or chromium. In one example, the second metallic layer 306 comprises copper, or a copper alloy, and the metallic layer 208 comprises aluminum, or an aluminum alloy.

In one embodiment, the second metallic layer 306 comprises two layers, a seed or initiation layer and a bulk metal layer formed on the seed or initiation layer. The initiation layer may comprise catalytic materials which may be used to initiate an electroless plating process, and the second metallic layer 306 may comprise catalytic materials which include but are not limited to palladium, tin, platinum, gold, rhodium, ruthenium, magnesium, osmium, iridium, iron, copper, cobalt, lead, mercury, nickel, aluminum, titanium, and carbon. The seed or initiation layer may also comprise non-metallic materials. In one embodiment, the second metallic layer 306 comprises aminopropyltriethoxysilane (APTS) and metallic materials.

The protective coating layer 308 comprises one or more layers of material which may function to protect, seal, and/or electrically insulate the underlying battery layers. The protective coating layer 308 comprises materials which may include but are not limited to lithium phosphorous oxynitride (LiPON), metal oxides, polymers, polyxylene polymers, polyethylene, polytetrafluoroethylene (PTFE), polypropylene, elastomers, resins, epoxies, silicones, dielectric adhesives, metals (e.g., stainless steel, aluminum), dielectrics, ceramics (e.g., Al₂O₃), glasses, rubber materials, or combinations thereof. The protective coating layer 308 may also be formed by treating the surface of the second metallic layer 306 to provide the desired protective properties. The treated surface layer(s) may include oxidized layers, anodized layers, or other treatment layers. In one embodiment, the protective coating layer 308 comprises lithium phosphorous oxynitride (LiPON).

The battery fiber 300 may be patterned during or after deposition of the material layers so that the cathode current collector and the anode current collector are exposed at desired locations along the fiber length so that an electrical load, another battery fiber 300, or a battery charging source, for example, may be electrically coupled to the current collectors. Various patterning and material removal techniques may be used such as masking, photolithography, thin-film patterning, selective deposition, etching, chemically removing, mechanically removing, laser ablation, laser scribing, or other techniques which provide the desired control for patterning and removing the material layers.

The material layers of the battery fiber 300 may be patterned to form various configurations for the boundaries of the material layers, and many configurations are possible and the configuration shown in FIG. 3A is not meant to be limiting. In one embodiment, the boundaries of the material layers are each highlighted by index locations 310A-E. For example, the metallic layer 208 is absent from the battery fiber 300 between the index location 310A and the index location 310B, the electrolyte/separator layer 302 is absent from the battery fiber 300 between the index location 310A and the index location 310C, thereby exposing the metallic layer 208 between the index locations 310B-C, the cathode layer 304 and second metallic layer 306 are absent from the battery fiber 300 between the index location 310A and the index location 310D, and the protective coating layer 308 is absent from the battery fiber 300 between the index location 310A and the index location 310E, thereby exposing the second metallic layer 306 between the index locations 310D-E.

The index locations 310A-E may be disposed at one or both ends of the battery fiber 300, or at various locations or intervals along the length of the battery fiber 300 so that the material layer pattern repeats along the battery fiber 300. Although five index locations 310A-E are shown, any number of locations may be used to indicate the desired material layer pattern. The index locations 310A-E shown on the right side of FIG. 3A are mirrored by a second group of index locations 310A-E on the left which have been omitted for clarity. The embodiments shown in FIG. 3A are not meant to be limiting, since other material layer patterns may be used to with out deviating from the basic scope of the invention described herein.

Each of the material layers of the battery fiber 300 may be formed to various desired thicknesses. The electrolyte/separator layer 302 has a thickness “t₅”, the cathode layer 304 has a thickness “t₆”, the second metallic layer 306 has a thickness “t₇”, and the protective coating layer 308 has a thickness “t₈”. Each thickness “t₅”, “t₆”, “t₇”, and “t₈” may range from a few nanometers to a few micrometers or more. In one embodiment, each thickness “t₅”, “t₆”, and “t₇” may range from about 0.01 micrometers to about 5 micrometers. In one embodiment, the thickness “t₅” of the electrolyte/separator layer 302 ranges from about 0.1 micrometers to about 3 micrometers. In one embodiment, the thickness “t₄” (see FIG. 2) of the metallic layer 208 and the thickness “t₇” of the second metallic layer 306 each range from about 0.1 micrometers to about 50 micrometers, or between about 0.1 micrometers to about 30 micrometers.

FIG. 3B is a schematic cross-sectional view of the battery fiber 300 shown in FIG. 3A after battery charging according to one embodiment described herein. After the battery fiber 300 has been formed, a layer of anodic material may be deposited in-situ by an initial charging of the battery fiber 300 to form an anode layer 309 which is disposed between the metallic layer 208 and the electrolyte/separator layer 302. This method of forming the anode layer 309 is sometimes called “in-situ activation”. After charging, the battery fiber 300 is activated and may deliver power to an electrical load connected to the battery electrodes/current collectors. Methods of in-situ activation are disclosed by Neudecker et al. in U.S. Pat. No. 6,168,884.

In another embodiment, FIG. 3B represents a cross-sectional view of the battery fiber 300 before battery charging, and the anode layer 309 is deposited on the metallic layer 208 before depositing the electrolyte/separator layer 302. The anode layer 309 may also comprise one or more layers of anodic material.

The anode layer 309 may also be formed on the metallic layer 208 after the electrolyte/separator layer 302 has been deposited but before deposition of the other battery layers when using LiPON for the electrolyte/separator layer 302. Methods for electrochemically depositing lithium on metals at metal/LiPON interfaces are disclosed by J. Klassen in U.S. Pat. No. 7,211,351.

The anode layer 309 comprises anodic materials which may include but are not limited to lithium, alkali metals, alkaline earth metals, transition metals, carbon, graphite, sodium, sodium-lead alloys, tin nitrides, including Sn₃N₄, lithium nitrides, including Li₃N, lithium-metal alloys including lithium-aluminum alloys, lithium-bismuth alloys, lithium-cadmium alloys, lithium-magnesium alloys, lithium-lead alloys, lithium-antimony alloys, lithium-tin alloys, lithium-zinc alloys, alloys comprising intermetallic compounds, including tin-based alloys such as copper-tin alloys, iron-tin alloys, nickel-tin alloys, tin-antimony alloys, and cobalt-tin-copper alloys, silicon-based alloys, including lithium-silicon alloys, tungsten oxide based alloys, metal alloys containing alkali metals, alkaline earth metals, and/or transition metals, and combinations thereof. In one embodiment, the anode layer 309 comprises metallic lithium, and/or composites containing materials, such as graphite, tin, silicon, and carbon black.

The anode layer 309 has a thickness “t₉” which may range from 0.01 micrometers to about 5 micrometers, although other thicknesses may be used. A total thickness “t₁₀” measured inclusively from the metallic layer 208 to the second metallic layer 306 may range from about 5 micrometers to about 40 micrometers, but other thicknesses are possible. In one embodiment, the thickness of the metallic layer 208 or the second metallic layer 306 is greater than the thicknesses of each anode layer 309, electrolyte/separator layer 302, or cathode layer 304.

In another embodiment, the battery fiber 300 may be formed so that the anode layer 309 and cathode layer 304 are disposed in reverse order in the battery fiber 300. For example, the battery fiber 300 comprises the cathode layer 304 which may be formed over the metallic layer 208, the electrolyte/separator layer 302 is then formed over the cathode layer 304, and the second metallic layer 306 is formed on the electrolyte/separator layer 302, and the protective coating layer 308 may be deposited on the second metallic layer 306. The anode layer 309 is formed between the electrolyte/separator layer 302 and the second metallic layer 306 during battery charging (in situ formation) or by depositing anodic material on the electrolyte/separator layer 302 before depositing the second metallic layer 306. In the reverse order embodiment, the metallic layer 208 comprises the cathode current collector and the second metallic layer 306 comprises the anode current collector.

FIG. 3C is a schematic cross-sectional view of the battery fiber 300 shown in FIG. 3B according to one embodiment described herein. The material layers of the battery fiber 300 conform to the circular cross-sectional shape of the metallized fiber 200 to form a battery fiber 300 having a circular cross-section. In another embodiment, the battery fiber 300 may have other cross-sectional shapes, such as oval, square, rectangular, hexagonal, octagonal, polygonal, or lobed, for example, depending on the cross-sectional shape of the metallized fiber 200.

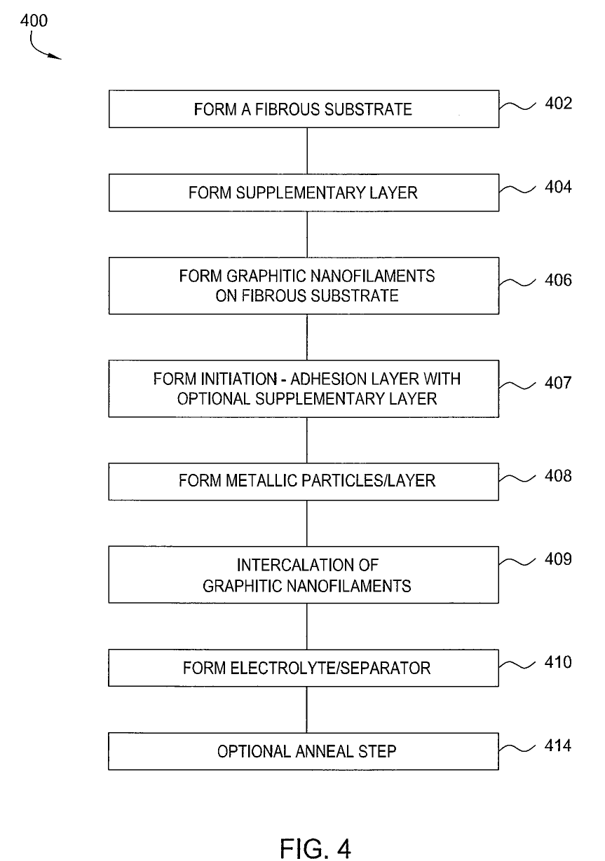

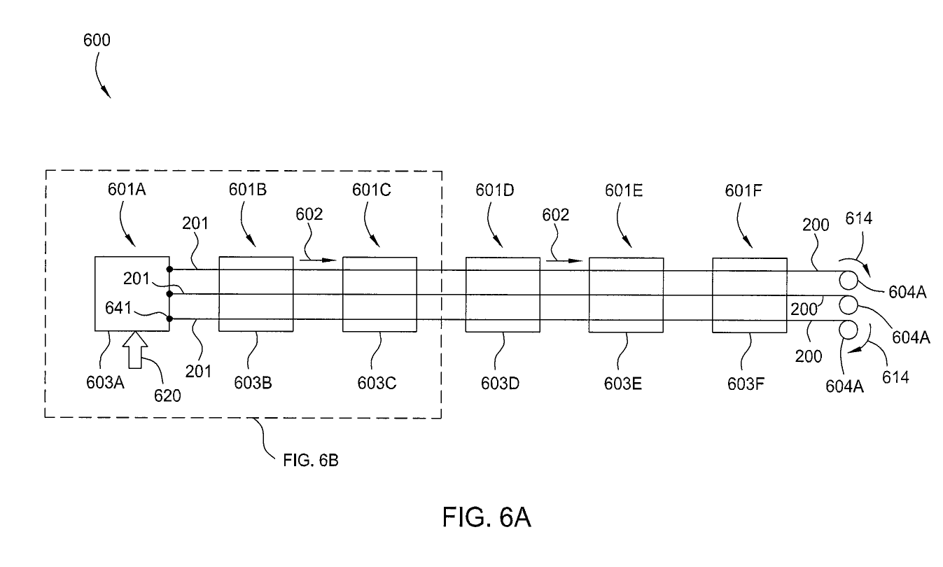

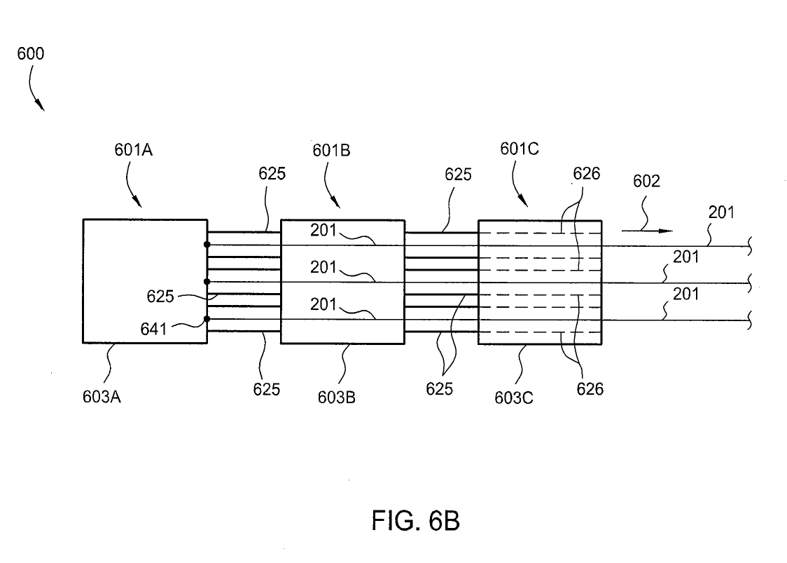

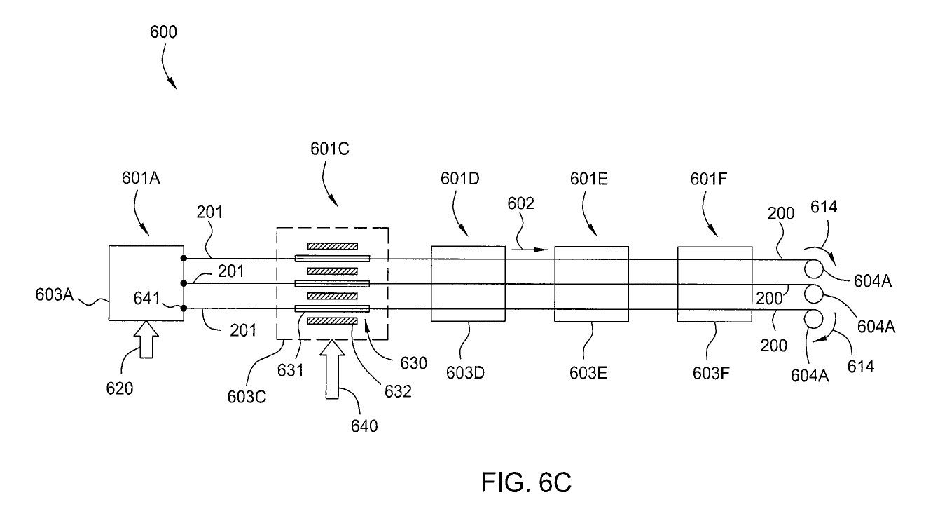

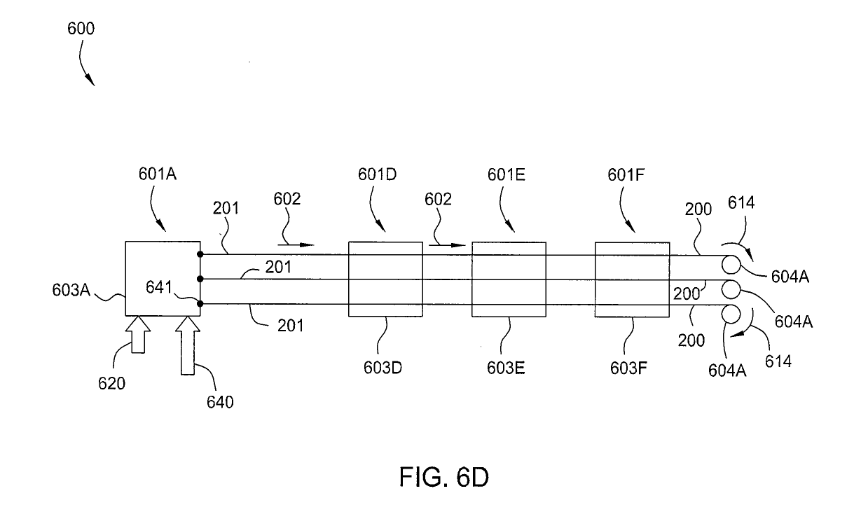

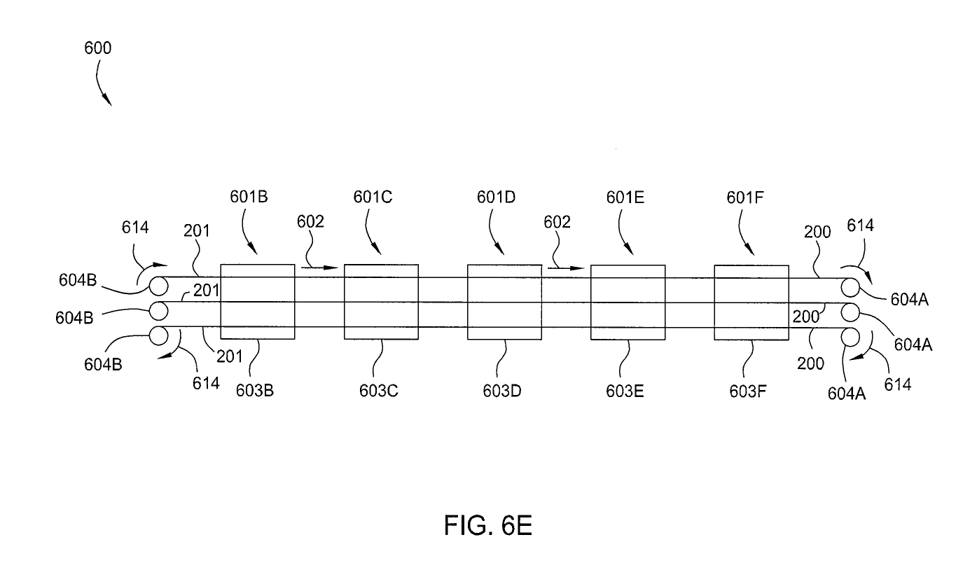

FIG. 4 illustrates a process for forming the metallized fiber 200 shown in FIG. 2 and the anodic portion of a battery according to one embodiment of the invention. The process comprises a series of method steps 400 which start with an step 402 which comprises forming the fibrous substrate 201 using a fiber forming apparatus (see FIG. 6A). In another embodiment, a commercially available fibrous substrate 201 is used to form the metallized fiber 200 and the step 402 is omitted.

The fibrous substrate 201 forming process of step 402 may comprise extruding thick, viscous liquids or sols or gels (of sol-gel compositions) through one or more holes in a portion (e.g., spinneret) of a fiber forming apparatus. Upon extrusion, liquid or gel fibers emerge from the holes and are converted first to a semi-solid state and then solidified during the fiber forming process. Various processes may be used to convert the liquid or gel fibers to a semi-solid and then solid state depending on the fiber forming process used. The fibrous substrate 201 may be continuous and have extended lengths or may be discrete and have limited or shorter lengths. As described herein, the term “spinning” refers to the process of extrusion and solidification to form fibers. The extruded fibers may also be drawn or stretched while in a semi-solid state or solid state to help align molecular chains within the fibers and improve various properties (e.g., strength) of the fibers. The extruded fibers may also be combined to form strands of fibers.

The fibrous substrate 201 may be formed from fiber precursor materials 620 (see FIG. 6A) that may comprise liquids, gels, or solids that are further processed to form the fibrous substrate 201. Solid materials must be converted into a fluid state before extrusion or drawing, and the materials may be melted, dissolved using suitable solvents, or chemically treated to form fluid chemical derivatives. In one embodiment, the fiber forming apparatus is adapted for heating the fiber precursor materials 620. In one embodiment, the fiber precursor materials 620 are melted before extrusion. In one embodiment, the fiber precursor materials 620 are heated to a temperature ranging from about 20° C. to about 500° C. The fiber precursor materials 620 may include but are not limited to polymers, thermoplastics, carbon-containing compounds, cellulosics, carbides, silica, aluminum oxide, lead zirconium titanate, glasses, ceramics, aramid, aromatic polyamides, polyethylene, polyamides, nylon, acrylics, metal alkoxides, silicon alkoxides, rayon, mesophase pitch, polyacrylonitrile (PAN), carbon nanotubes, carbon nanofibers, or derivatives, precursors and combinations thereof. In one embodiment, the fiber precursor material 620 comprises a sol-gel composition. The fibrous substrates 201 may also be formed using another method known in the art such as fiber drawing. In this method, the surface of a viscous liquid comprising the fiber precursor material 620 is contacted by a projection with a sharp tip and the sharp tip is dipped temporarily into the surface of the viscous liquid and then pulled up to draw continuously the viscous liquid in the shape of a fiber. The continuous fiber drawn from the viscous liquid is then passed through a heating apparatus or other apparatus to solidify the fiber, and the solid fiber may then be wound up on a spool or take-up reel which pulls up the fiber. The fibrous substrates 201 may also be formed using various fiber-forming methods which may include but are not limited to wet spinning, dry spinning, melt spinning, dry-wet spinning, gel spinning, sol-gel spinning, dry jet wet spinning, coagulation spinning, fiber drawing, and sol-gel fiber drawing. In one embodiment, each fibrous substrate 201 is formed using sol-gel or gel spinning in which the sol or gel of a sol-gel composition is extruded through a hole and then solidified.

At step 404, a supplementary layer 203 may be formed on one or more surfaces of the fibrous substrate 201. The supplementary layer 203 may be patterned using various patterning techniques, which include but are not limited to laser ablation, masking, screen printing, ink jet printing, lithography, localized spray deposition, localized painting, and selective etching. The patterning of the supplementary layer 203 may be used to control where graphitic nanofilaments grow on the surface or surfaces of the fibrous substrate 201 in a subsequent step, and may enhance the mechanical or surface properties of the fibrous substrate 201. For example, catalytic materials may be deposited and patterned to control where graphitic nanofilaments grow on the fibrous substrate 201. In another embodiment, the metallized fiber 200 comprises two or more supplementary layers 203 are formed by repeating step 404 multiple times or after performing any one of the subsequent method steps 400. In one configuration, the one or more of the deposited supplementary layers 203 is a catalytic layer, such as a second layer 203B, that further helps to facilitate or control the formation of graphitic nanofilaments. In one embodiment, the one or more of the deposited supplementary layers 203 comprises a current collecting layer 203A and a second layer 203B.

The supplementary layer 203 may be formed by treating the one or more surfaces of the fibrous substrate 201 and/or by depositing supplementary materials thereon. The treatments may include but are not limited to heating, etching, irradiating, anodizing, and oxidizing. The supplementary materials may be deposited using wet or dry deposition techniques which include but are not limited to sputtering, chemical vapor deposition, plasma enhanced chemical vapor deposition, electrochemical deposition, electroless deposition, selective wetting, ion beam assisted sputtering, electrophoretic deposition, and cathodic arc and laser ablation of carbon targets. In one embodiment, the supplementary materials comprise catalytic materials which may be deposited using methods which include but are not limited to sputtering, thermal evaporation, CVD, applying catalyst-containing solutions, applying catalyst-containing colloidal solutions, applying catalyst-containing sol-gels, electrochemical plating, and electroless plating. In one example, the catalytic materials may include but are not limited to iron, cobalt, nickel, copper, silver, magnesium, ruthenium, rhodium, iridium, platinum, palladium, molybdenum, tungsten, chromium and alloys, oxides, and combinations thereof.

The step 404 may comprise multiple steps for forming the supplementary layer 203 which may comprise multiple treatment and deposition layers. For example, one or more surfaces of the fibrous substrate 201 may be oxidized to form an oxide layer followed by depositing a first catalytic material to form a first catalyst layer on the oxide layer and then depositing a second catalytic material to form a second catalyst layer on the first catalyst layer. Alternate treatments, supplementary materials, and sequences of deposition and treatment may be contemplated for the supplementary layer 203.

Next, in an optional step 406, graphitic nanofilaments are formed on one or more surfaces of the fibrous substrate 201 to produce the nanofilament layer 204. The nanofilament layer 204 may be formed using catalytic or non-catalytic CVD methods. The methods which use catalyst materials to facilitate and help control the growth of graphitic nanofilaments are referred to as catalytic CVD methods. The methods which use no catalyst materials for graphitic nanofilament growth are referred to as non-catalytic or pyrolytic CVD methods since only heating, and not catalysis, typically drives nanofilament growth. The catalytic CVD methods often provide greater control over graphitic nanofilament growth than non-catalytic methods. In one embodiment, catalyst materials used to form the graphitic nanofilaments are deposited on the fibrous substrate 201 before the step 406. In another embodiment, catalyst materials are deposited on the fibrous substrate 201 during the step 406, such as when using the floating catalyst method of graphitic nanofilament formation, for example. In one embodiment, the nanofilament layer 204 is formed using a catalytic CVD method.

In one embodiment, the “floating catalyst” method is used to form the nanofilament layer 204, and catalyst-containing materials are injected directly into a graphitic nanofilament growth chamber. The catalyst-containing materials may be injected before, during, or after the injection of a carbon source gas. The catalyst-containing materials may comprise catalyst particles or catalyst precursors from which the catalyst particles are formed.

The catalyst precursors may comprise liquid catalyst mixtures, organometallic catalyst compounds, or other materials which contain catalysts. The liquid catalyst mixtures may comprise solutions, suspensions, or colloids of catalyst materials. The organometallic catalyst compounds may include but are not limited to iron pentacarbonyl, iron(II)phthalocyanine, ferrocene, nickelocene, cobaltocene, and other metallocenes. The catalyst precursors may be injected in either gas, liquid, or solid phase using atomizers, syringe pumps, showerheads or other injecting means. After injection, the catalyst precursors may be converted into catalyst particles by various means such as heating, reducing, decomposing, vaporizing, condensing, and sublimating, for example.

In the floating catalyst method, a graphitic nanofilament may grow from a catalyst particle as the particle falls from the top to the bottom of the growth chamber or after the catalyst particle has come to rest upon a surface within the chamber. If a substrate is included within the growth chamber, many catalyst particles may come to rest upon the surface of the substrate and graphitic nanofilaments may form on the substrate surface. The floating catalyst method may, under certain conditions, be used to form many densely packed and aligned graphitic nanofilaments on the surface of a substrate.

The graphitic nanofilaments may be formed using various CVD techniques which include but are not limited to atmospheric pressure CVD (APCVD), low pressure CVD (LPCVD), high pressure CVD (HPCVD), plasma enhanced CVD (PECVD), laser-enhanced CVD, thermal CVD, metal-organic CVD (MOCVD), hot filament CVD, and combinations thereof. In one embodiment, low pressure CVD (LPCVD) is used to form the graphitic nanofilaments.

The graphitic nanofilament type (nanotube or nanofiber), structure (single-walled, multi-walled, herringbone, etc.), diameter, length and alignment may be controlled by controlling the CVD growth parameters. The growth parameters include but are not limited to carbon source gas, carrier gas, growth temperature, growth pressure, and growth time. For catalytic CVD growth, additional growth parameters may include catalyst parameters such as catalyst size, shape, composition, and catalyst precursors. The parameter ranges and options for catalytic CVD growth, excluding catalyst parameters, may, in general, be applicable to the non-catalytic CVD growth of graphitic nanofilaments, although higher temperatures may be used for the non-catalytic CVD methods.

In one embodiment, the temperatures for the catalytic CVD growth of graphitic nanofilaments may range from about 300 degrees Celsius (° C.) to about 3,000 degrees Celsius (° C.), but preferably from about 500° C. to about 700° C., although temperatures lower than 500° C. may be used, especially if the CVD growth is plasma enhanced. The growth pressures may range from about 0.1 Torr to about 1 atmosphere, but more preferably from about 0.1 Torr to about 100 Torr, although lower or higher pressures may also be used. In another embodiment, the growth pressures are above atmospheric pressure, and may range from about 1 atmosphere to about 10 atmospheres. The growth time or “residence time” depends in part on the desired graphitic nanofilament length, with longer growth times producing longer lengths. The growth time may range from about ten seconds to many hours, but more typically from about ten minutes to several hours.

The process of forming the nanofilament layer 204 and the graphitic nanofilaments therein comprises flowing a carbon source gas over the fibrous substrates 201. The carbon source gas used for graphitic nanofilament growth may include but is not limited to ethylene, propylene, acetylene, benzene, toluene, ethane, methane, butane, propane, hexane, methanol, ethanol, propanol, isopropanol, carbon monoxide, acetone, oxygenated hydrocarbons, low-molecular-weight hydrocarbons, or combinations thereof. In general, the carbon source gas may comprise any carbon-containing gas or gases, and the carbon source gas may be obtained from liquid or solid precursors for the carbon-containing gas or gases. An auxiliary gas may be used with the carbon source gas to facilitate the growth process. The auxiliary gas may comprise one or more gases, such as carrier gases, inert gases, reducing gases (e.g., hydrogen, ammonia), dilution gases, or combinations thereof, for example. The term “carrier gas” is sometimes used in the art to denote inert gases, reducing gases, and combinations thereof. Some examples of carrier gases are hydrogen, nitrogen, argon, and ammonia.

The CVD growth parameters for graphitic nanofilament growth may also include parameters which facilitate the alignment of the graphitic nanofilaments on a substrate. The alignment parameters may include but are not limited to electric field direction and intensity, catalyst particle density, and substrate pore orientation. In one embodiment, the graphitic nanofilaments are aligned by applying an electric field near the nanofilaments and the nanofilament lengths align in a direction approximately parallel to the direction of the electric field. The electric field may be produced by plasmas or other means.

In another embodiment, the graphitic nanofilaments are aligned in the absence of electric fields by controlling the density of graphitic nanofilaments on the surface of the fibrous substrate 201. For sufficiently high densities, the graphitic nanofilaments align parallel to each other. The alignment of graphitic nanofilaments due to dense packing is sometimes referred to as “self-oriented” or “self-assembled” growth.

In yet another embodiment, the graphitic nanofilaments are aligned using aligned or oriented pores or holes in the surface upon which the graphitic nanofilaments are grown, as described herein. In one embodiment, the aligned pores or holes are formed by anodizing the growth surface. As defined herein, “non-aligned” graphitic nanofilaments are randomly oriented with respect to each other and the surface upon which they are grown. In one embodiment, the nanofilament layer 204 comprises non-aligned graphitic nanofilaments.

Some of the method steps 400 may also be combined to reduce the processing time for forming the metallized fiber 200. In one embodiment, the step 402 is combined with the step 404 and/or the step 406. For example, the fibrous substrate 201 and nanofilament layer 204 may be formed in parallel or in a manner which combines the formation of the fibrous substrate 201 and the nanofilament layer 204 to reduce the overall processing time for forming the metallized fiber 200, and the apparatus (see FIG. 6D) for forming the fibrous substrate 201 may be adapted to also form the nanofilament layer 204.

In the next step, or step 407, the initiation-adhesion layer 206 is optionally formed over the nanofilament layer 204. In another embodiment, the initiation-adhesion layer 206 is formed on the fibrous substrate 201 or supplementary layer 203 when the step 406 is omitted. Step 407 generally comprises one or more steps which prepare the fibrous substrate 201 for the deposition of metallic materials thereon. In general, step 407 could entail depositing materials, removing materials, and/or removing contamination, or cleaning, operations. For example, various treatments may be applied to the nanofilament layer 204 to remove catalyst materials remaining in the graphitic nanofilaments. Such treatments may include applying solutions which contain acids (e.g., hydrochloric, sulfuric, nitric, etc.) to the nanofilaments or exposing the nanofilaments to plasmas.

In one embodiment, the initiation-adhesion layer 206 may be deposited using deposition techniques which include but are not limited to sputtering, chemical vapor deposition, atomic layer deposition, electrochemical deposition, electroless deposition, and electrophoretic deposition. Various materials which may be deposited are described herein relating to the initiation-adhesion layer 206. In one embodiment, the initiation-adhesion layer 206 comprises a seed or nucleation layer. In another embodiment, the initiation-adhesion layer 206 comprises a layer which prepares the fibrous substrate 201 for electroless depositon of the metallic layer 208. The step 407 may comprise multiple steps such as cleaning, rinsing, sensitizing, and activating which are performed on the fibrous substrate 201 prior to the electroless deposition of a metal thereon. The electroless deposition process includes the immersion of the surface to be plated in one or more electroless plating solutions or baths that comprise a metal salt, such as salt of copper, lithium, tin, aluminum, bismuth, antimony, nickel, titanium, vanadium, chromium, manganese, iron, cobalt, silver, gold, or zinc. The electroless plating solutions are typically aqueous solutions which include a metal salt containing the plating metal, one or more reducing agents, complexing agents, pH adjusters, and other additives to control solution stability, film properties, and metal deposition rate.

In one embodiment, the step 407 comprises the immersion of the fibrous substrate 201 into one or more solutions which include but are not limited to sensitizing solutions, activating solutions, plating solutions, etching solutions, cleaning solutions, rinsing solutions, or other surface treating solutions and combinations thereof which form the initiation-adhesion layer 206. As defined herein, “immersion” may mean submerging a body in liquid or contacting only one or more surfaces of the body with a liquid.

The sensitizing solution may comprise an aqueous solution which includes an acid (e.g., hydrochloric (HCl), sulfuric (H₂SO₄)) and a sensitizing agent such as tin chloride (SnCl₂), tin fluoride (SnF₂), platinum chloride (PtCl₂), or titanium chloride (TiCl₂), although other sensitizing agents may be used. The activating solution may comprise an aqueous solution which includes an acid (e.g., hydrochloric (HCl), sulfuric (H₂SO₄)) and an activating agent, such as palladium chloride (PdCl₂), for example, although other activating agents may be used. The sensitizing and activating agents may comprise metal salts or other chemical compounds which include catalytic materials (e.g., metals) which may initiate the electroless deposition of a metal. The catalytic materials may include but are not limited to palladium, tin, platinum, gold, rhodium, ruthenium, magnesium, osmium, iridium, iron, copper, cobalt, lead, mercury, nickel, aluminum, titanium, and carbon. In one embodiment, the fibrous substrate 201 is immersed in the sensitizing or activating solution for a duration of about 1 minute to about 30 minutes.

Referring to FIG. 4, in one embodiment, in a step 408, a metallic layer 208 is deposited over the graphitic nanofilaments in the nanofilament layer 204 using one or more deposition techniques which include but are not limited to sputtering, chemical vapor deposition, plasma enhanced chemical vapor deposition, atomic layer deposition, metal-organic chemical vapor deposition, electrochemical deposition, electroless deposition, and electrophoretic deposition. In one embodiment, in a step 408, a metallic layer 208 is deposited over an initiation-adhesion layer 206 that is disposed on the nanofilament layer 204. The step 407 may comprise multiple steps for depositing multiple metal layers which form the metallic layer 208, and each metal layer may be deposited using a different deposition technique.

In one embodiment, the metallic layer 208 is deposited using electroless deposition. The graphitic nanofilaments and/or initiation-adhesion layer 206 formed in the steps 406 and/or 407 can provide a suitable catalytic material which can initiate an electroless plating process. The nanofilament layer 204 and/or initiation-adhesion layer 206 is then immersed into one or more electroless plating solutions containing metal ions which are reduced to the metallic state to form the metallic layer 208. The nanofilament layer 204 and/or initiation-adhesion layer 206 may be immersed sequentially into a series of electroless plating solutions to deposit one or more metal layers which form the metallic layer 208. The thickness “t₄” of the metallic layer 208 depends in part on the duration of immersion of the nanofilament layer 204 and/or initiation-adhesion layer 206 in each of the one or more plating solutions, and the thickness of each metal layer increases with a longer immersion time. The electroless plating solutions may also be heated to increase the deposition rate. In one embodiment, the electroless plating solutions are heated to temperatures ranging from about 18° C. to about 95° C. In one embodiment, the nanofilament layer 204 and/or initiation-adhesion layer 206 is immersed in an electroless plating solution for a period ranging from about 5 minutes to about 60 minutes.

In another embodiment, the metallic layer 208 is deposited using electrochemical deposition and the nanofilament layer 204 and/or initiation-adhesion layer 206 comprises an electrically conductive nucleation or seed layer which enables the electrochemical plating of a metal thereon. The nanofilament layer 204 and/or initiation-adhesion layer 206 is immersed into a plating solution which comprises an electrolyte bath in which is disposed an electrode (e.g., anode) comprising the metal to be plated. The nanofilament layer 204 and/or initiation-adhesion layer 206 functions as a counter-electrode (e.g., cathode) and the electrodes are suitably connected to a power supply which provides a plating current for depositing metal over the nanofilament layer 204. The plating current may be a direct current (DC) or a pulsed plating waveform delivered by the power supply. The nanofilament layer 204 and/or initiation-adhesion layer 206 may be immersed into a series of electrolyte solutions to deposit multiple metal layers which form the metallic layer 208. The electrolyte solution typically comprises an aqueous bath which includes a metal salt containing the metal to be plated, an acid (or base), and additives. The additives (e.g., levelers, brighteners, surfactants) may be added to improve the quality and conformality of the deposited metal layer.

Each of the steps 407 and 408 may also comprise the deposition of one or more supplementary materials described herein which may enhance or modify properties of the metallized fiber 200, and such materials may include diamond, diamond-like carbon (DLC), fluorinated carbon, silicates, metal oxides, metal fluorides, ceramics, or polymers, or other materials. The properties of the metallized fiber 200 which may be enhanced or modified include but are not limited to flexural rigidity, thermal and/or electrical conductivity, coefficient of thermal expansion, wear resistance, and other properties. Diamond or DLC, for example, may be deposited onto a flexible fibrous substrate 201 to improve the flexural rigidity of the fibrous substrate 201.

The supplementary materials may be deposited using the deposition techniques described herein for forming the supplementary layer 203 in the step 404. The supplementary materials may also be co-deposited with other materials which are used to form the initiation-adhesion layer 206 and the metallic layer 208. For example, the supplementary materials may be co-deposited with sensitizing agents, activating agents, seed layers, nucleation layers, initiating layers, and/or metal plating layers. The supplementary materials may also be deposited before or after each of the steps 407 and 408. In one embodiment, a supplementary material is deposited using more than one deposition technique, such as electrophoretic deposition followed by electrochemical plating, for example. In one embodiment, supplementary materials comprising diamond or DLC are co-deposited with other materials which are used to form the initiation-adhesion layer 206 or the metallic layer 208.

Methods for depositing supplementary materials (e.g., diamond, DLC, fluorinated carbon) using wet deposition processes such as electrochemical deposition, electroless deposition, or electrophoretic deposition are disclosed in U.S. Pat. Nos. 3,753,667, 5,836,796, and 6,156,390. A powder comprising particles of supplementary material may be prepared and added to one or more solutions which are used in the wet deposition process, such as sensitizing solutions, activating solutions, electroless plating solutions, or electrochemical plating solutions, for example. In one embodiment, the size of the particles of the supplementary material is controlled to have an average diameter of less than a few tens of nanometers, although other particle sizes (e.g., sub-micrometer, micrometer) may be used depending upon the material, deposition solution, and deposition technique used. For example, the size of diamond or DLC particles may be controlled to have an average diameter of less than about 10 nanometers.

The particles of supplementary material may be co-deposited with a metal onto a plating surface during a wet deposition process, such as electrochemical or electroless deposition, for example. The metal particles in the electroless or electrochemical solution may entrain the particles of supplementary material during the deposition process so that both the metal and supplementary material are co-deposited onto the plating surface. Alternately, the wet deposition process (e.g., electrophoretic deposition) may deposit only the supplementary material onto a surface without co-depositing other materials. In one embodiment, a supplementary material is co-deposited with a metal in an electroless or electrochemical plating solution in the step 407. In another embodiment, a supplementary material is co-deposited with a metal in an electroless or electrochemical plating solution in the step 408. In one embodiment, the supplementary material comprises diamond or DLC.

In one example of process steps 407 and 408, step 407 comprises depositing tin (Sn) using a sensitizing solution, followed by depositing palladium (Pd) using an activating solution, followed by depositing nickel (Ni) using an electroless plating solution to form an initiation-adhesion layer 206 comprising tin (Sn), palladium (Pd), and nickel (Ni). Then in step 408, a copper layer is deposited onto the initiation-adhesion layer 206 using an electrochemical deposition process.

In another example of process steps 407 and 408, step 407 comprises depositing tin (Sn) using a sensitizing solution, followed by depositing palladium (Pd) using an activating solution, to form an initiation-adhesion layer 206 comprising tin (Sn) and palladium (Pd), and step 408 comprises depositing copper onto the initiation-adhesion layer 206 using electroless deposition to form a copper metallic layer 208.

In an example of process steps 407 and 408, step 407 comprises depositing aminopropyltriethoxysilane (APTS) using a solution comprising the silanization reagent APTS to form a thin film of self-assembled monolayers (SAMs) of APTS on the fibrous substrate 201, and then depositing palladium (Pd) using an activating solution to form an initiation-adhesion layer 206 comprising aminopropyltriethoxysilane (APTS) and palladium (Pd). Then in step 408, a copper layer is deposited onto the initiation-adhesion layer 206 using an electroless deposition process. Methods for electroless metal plating using APTS self-assembled monolayers are reported by Xu et al., in “A New Activation Method for Electroless Metal Plating: Palladium Laden via Bonding with Self-Assembly Monolayers,” Chinese Chemical Letters, Vol. 13, No. 7, pp. 687-688, 2002.

In another example of process steps 407 and 408, step 407 comprises depositing a copper seed layer using a physical vapor deposition (PVD) technique, such as sputtering or thermal evaporation, and, in the step 408, copper is electrochemically deposited onto the PVD seed layer.

In another example of process steps 407 and 408, step 407 comprises depositing a copper seed layer using a chemical vapor deposition (CVD) process, and step 408 comprises depositing copper onto the seed layer using an electroless deposition process. After the metallized fiber 200 has been formed, the battery fiber 300 may be formed by forming additional material layers on the metallized fiber 200.

Referring to FIG. 4, in a step 409, the metallized graphitic nanofilaments may be intercalated with species (e.g., ions) of metals, such as the alkali metals (e.g., lithium, sodium, potassium, rubidium, etc.), for example. In one example, the metallized graphitic nanofilaments are intercalated with a lithium material to form a lithiated anodic material. In another embodiment of process 400, the metallic layer 208 is not deposited over the graphitic nanofilaments and thus no metallic material is disposed between the graphitic nanofilaments and the intercalation material. The term “intercalation” may be defined as the reversible insertion of guest species (e.g., ions, atoms, molecules) into a solid host material without a major disruption or change of the host material. A host material (e.g., graphitic nanofilaments) which may be intercalated has the property which allows guest species (e.g., metal ions) to readily move in and out of the host material without the host material changing its phase.

The intercalation of the metallized, or unmetallized, graphitic nanofilaments may be desirable when the fibrous substrate 201 forms part of an energy storage device. The large surface areas of metallized, or unmetallized, graphitic nanofilaments may be used to create porous electrodes with superior ion storage and reversibility capacities and such electrodes may be used in high performance energy storage devices such as rechargeable batteries (e.g., lithium-ion batteries). Reversible specific capacities for accepting lithium for single-walled carbon nanotubes have been reported by Zhou et al. (U.S. Pat. No. 6,422,450) at values of about 550 milliampere-hours per gram (mAh/g) and higher compared to a maximum (theoretical) reversible capacity of about 372 mAh/g for graphite.

The metallized, or unmetallized, graphitic nanofilaments may be intercalated with metal ions using various electrochemical, chemical, or physical methods. In electrochemical methods the graphitic nanofilaments form part of an electrode in a cell which includes an electrolyte and a counter-electrode which acts as a source for the metal ion. The cell is then charged and the metal ions leave the counter-electrode and are inserted into the metallized, or unmetallized, graphitic nanofilaments. Other chemical methods include adding a metal salt (e.g., alkali metal salt) to a suitable solvent to form a solution containing the metal ions and then immersing the metallized, or unmetallized, graphitic nanofilaments into the solution to intercalate the metallized, or unmetallized, carbon nanofilaments with the metal ions. Alternately, physical transport methods (e.g., vapor diffusion) which expose the nanofilaments to a heated metal vapor may be used for some types of metal ions (e.g., potassium, sodium) to perform the intercalation. Other methods, however, may be contemplated for the intercalation of the metallized, or unmetallized, graphitic nanofilaments.

In the next step, or step 410, an electrolyte/separator layer 302 (FIG. 3A), is formed over the intercalated metallized, or unmetallized, graphitic nanofilaments. In one example, the electrolyte/separator layer 302 comprises LiPON, and the metallized fiber 200 is immersed in an electrolyte solution containing propylene carbonate/LiPF₆. In one embodiment, the electrolyte/separator layer 302 may comprise lithium phosphorous oxynitride (LiPON), lithium-oxygen-phosphorus (LNOP), lithium-phosphorus (LiP), lithium polymer electrolyte, lithium bisoxalatoborate (LiBOB), lithium hexafluorophosphate (LiPF₆) in combination with ethylene carbonate (C₃H₄O₃), and dimethylene carbonate (C₃H₆O₃). In another embodiment, ionic liquids may be deposited to form the electrolyte. In one embodiment, the electrolytic material is deposited over the metallized, or unmetallized, graphitic nanofilaments to form the electrolyte/separator layer 302. The electrolytic material may be deposited using techniques which include but are not limited to sputtering, magnetron sputtering, thermal evaporation, ion beam assisted sputtering, chemical vapor deposition, plasma enhanced chemical vapor deposition, atomic layer deposition, cathodic arc evaporation, and metal organic chemical vapor deposition. In one embodiment, the electrolytic material is deposited using a sputter deposition process. In another embodiment, the electrolytic material is deposited using wet deposition methods, such as electrochemical deposition, electroless deposition, and electrophoretic deposition, for example.

Referring to FIG. 4, in one embodiment, an optional anneal step may be performed at step 414 to stabilize or enhance the properties of one or more materials within the metallized fiber 200 formed using the steps 402-410. For example, the metallic layer 208 may be annealed to reduce the internal stresses within the metal and increase the metallic grain size to increase the conductivity of the metal. Annealing may also reduce some instabilities in the properties of the metallic layer 208. For example, the electrochemical deposition of copper can result in a self-annealing behavior of the copper following deposition. The self-annealing of the copper can occur at room temperature and can cause a gradual decrease in sheet resistance and hardness of the copper film. Annealing can decrease the time required to reach stable values for the sheet resistance and hardness of the copper layer.

Various parameters may be used for the annealing process in step 414. In one embodiment, the annealing temperature may range from about 75° C. to about 450° C. In one embodiment, the annealing time may range from about 1 minute to about 120 minutes. The annealing may be performed under vacuum or at atmospheric pressures or above, and may be conducted in environments containing inert gases (e.g., nitrogen, hydrogen, argon, helium) which prevent oxidation of the metallized fiber 200. The annealing process may also be conducted in an environment containing one or more gases which form a plasma.

The method steps 400 shown in FIG. 4 and described herein may also include additional cleaning and rinsing steps which may occur before, during, or after each of the steps 404, 406, 407, 408, 409, and 410. Also, any solutions which are used for processing may be heated and/or agitated to facilitate deposition, cleaning, rinsing, or other processing. The solutions may be agitated mechanically, ultrasonically, or by other means.

### Battery Fiber Formation Process

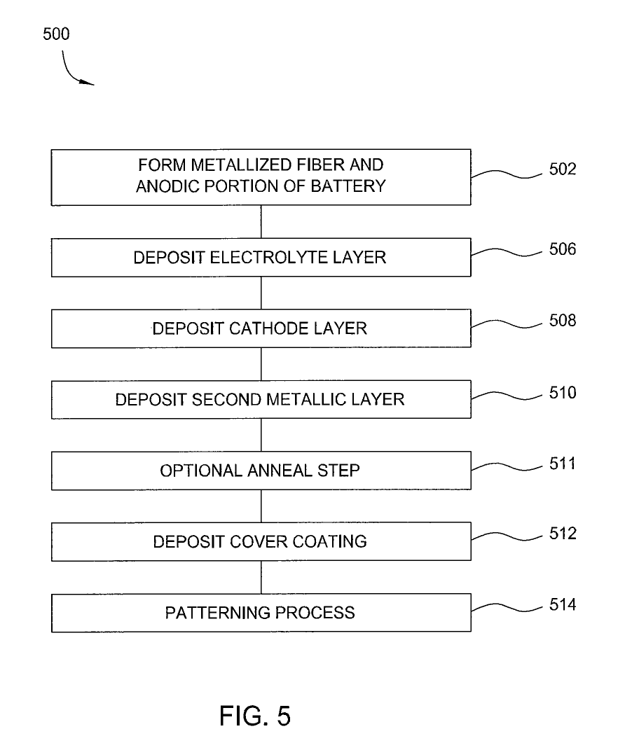

FIG. 5 illustrates a process for forming the battery fiber 300 shown in FIGS. 3A and 3B according to one embodiment of the invention. The process comprises a series of method steps 500 that start with step 502 which comprises forming the metallized fiber 200 and anodic portion of a battery fiber 300 using the process steps 402-409 discussed above in conjunction with FIG. 4 above, and thus are not re-recited herein.

In the next step, a step 506, an electrolytic material is deposited over the metallic layer 208, formed in step 502, to form the electrolyte/separator layer 302. In one embodiment, step 506 is similar to step 410 discussed above. The electrolytic material may be deposited using techniques which include but are not limited to sputtering, magnetron sputtering, thermal evaporation, ion beam assisted sputtering, chemical vapor deposition, plasma enhanced chemical vapor deposition, atomic layer deposition, cathodic arc evaporation, and metal organic chemical vapor deposition. In one embodiment, the electrolytic material is deposited using sputter deposition. In another embodiment, the electrolytic material is deposited using wet deposition methods, such as electrochemical deposition, electroless deposition, and electrophoretic deposition, for example. In one embodiment, the electrolytic layer 302 is annealed using step 414, which is discussed above, before the cathode layer 304 is deposited.

In another embodiment of method steps 500, the step 409 performed during step 502 is performed after the electrolyte/separator layer 302 is deposited in step 506 but before step 508, and the anode layer 309 is electrochemically deposited between the second metallic layer 306 and the electrolyte/separator layer 302. In one embodiment, the anodic material is a lithium containing material, the electrolyte/separator layer 302 comprises LiPON, and the metallized fiber 200 is immersed in an electrolyte solution containing propylene carbonate/LiPF₆. Methods for electrochemically depositing lithium on metals at metal/LiPON interfaces are disclosed by J. Klassen in U.S. Pat. No. 7,211,351. In yet another embodiment, the step 409 may be performed after the method step 508.

In a step 508, cathodic material is deposited on the electrolyte/separator layer 302 to form the cathode layer 304. The cathodic material may be deposited using deposition methods which include but are not limited to sputtering, magnetron sputtering, thermal evaporation, ion beam assisted sputtering, chemical vapor deposition, plasma enhanced chemical vapor deposition, atomic layer deposition, cathodic arc evaporation, and metal organic chemical vapor deposition. In one embodiment, the cathodic material is deposited using sputter deposition. In another embodiment, the cathodic material is deposited using wet deposition methods, such as electrochemical deposition, electroless deposition, electrophoretic deposition, or immersion in slurries, for example. In one embodiment, the cathode layer 304 is annealed after deposition of the cathode layer 304 and before the step 510. In one embodiment, the annealing temperature is less than or equal to about 300° C. In another embodiment, the annealing temperature ranges from about 300° C. to about 700° C.

In one embodiment, the cathode layer 304 forms part of an air cathode and the cathodic material may be deposited to form a porous layer. In one embodiment, the electrolyte/separator layer 302 is dipped or immersed into a slurry to form a porous cathode layer 304 on the electrolyte/separator layer 302.

Next, in a step 510, metallic materials are deposited on the cathode layer 304 to form the second metallic layer 306. The metallic materials may be deposited using wet or dry deposition techniques which include but are not limited to sputtering, ion beam assisted sputtering, magnetron sputtering, thermal evaporation, chemical vapor deposition, plasma enhanced chemical vapor deposition, atomic layer deposition, metal organic chemical vapor deposition, cathodic arc evaporation, electrochemical deposition, electroless deposition, and electrophoretic deposition. In one embodiment, the second metallic layer 306 is formed using electrochemical deposition, electroless deposition, and/or electrophoretic deposition.

In one embodiment, the step 510 comprises a two-step process: a first step in which a seed layer or initiation layer is deposited on the cathode layer 304 and a second step in which a bulk metal layer is deposited on the seed or initiation layer. The embodiments described herein for the steps 407 and 408 for forming the initiation-adhesion layer 206 and metallic layer 208 may also be applied to the step 510 for forming the second metallic layer 306. In one embodiment, the step 510 comprises depositing a non-metallic initiation layer, such as APTS, for example.

In a step 511, annealing may be performed to stabilize or enhance the properties of one or more materials within the battery fiber 300, such as the second metallic layer 306 or cathode layer 304, for example. Annealing embodiments and parameters described herein for the metallized fiber 200 may be used for annealing one or more of the material layers in the battery fiber 300. The annealing step 511 may be performed after any of the other method steps 500. Also, the optional step 511 may occur after any or all of the method steps 500 in order to anneal material layers in the battery fiber 300.

In the next step, a step 512, the second metallic layer 306 is covered with materials which form the protective coating layer 308. The protective coating layer 308 may be deposited using wet or dry deposition methods which include but are not limited to sputtering, ion beam assisted sputtering, chemical vapor deposition, plasma enhanced chemical vapor deposition, atomic layer deposition, metal organic chemical vapor deposition, electrochemical deposition, and electroless deposition. In one embodiment, the protective coating layer 308 is formed by contacting the second metallic layer 306 with one or more melts or solutions of the materials which comprise the protective coating layer 308.

The processing which occurs in each of the steps 504, 506, 508, 510, 511, and 512 may be performed under vacuum or at atmospheric pressures. In one embodiment, the dry deposition techniques are performed under vacuum, and the wet deposition techniques are performed at atmospheric pressures.

In the next step, a step 514, any of the layers in the formed battery fiber 300 are patterned to allow electrical connections to be made to one or more of the formed layers, such as the supplementary layer 203 and the second metallic layer 306. The patterning steps may include various patterning and material removal techniques which may include performing one or more etching or ablation step, or performing a masking step and an etching or ablation step. In one example, the masking steps may include, but are not limited to masking, photolithography, thin-film patterning, and/or selective deposition techniques, and the etching processes may include, but are not limited to wet etching, dry etching, chemically etching, mechanically material removal, laser ablation, and/or laser scribing. Step 514 may also be performed before, during, or after any one of the steps 502, 506, 508, 510, 511, and 512 discussed above. In one embodiment, step 514 is performed after performing each of the steps 502, 506, 508, 510, 511, and 512 discussed above. In addition to step 514, additional processing steps, such as cleaning steps or rinsing steps may be performed before, during, or after any of the steps 502, 506, 508, 510, 511, 512 and 514 discussed above.

In another embodiment, the sequence of the step 409 in step 502 is performed between steps 506 and 510 and step 508 occurs between steps 502 and 506, i.e., the cathode layer 304 is deposited onto the metallic layer 208 before depositing the electrolyte/separator layer 302, and the anode layer 309 is deposited (optionally) onto the electrolyte/separator layer 302 before depositing the second metallic layer 306.

### Multiple Battery Formation Process

FIG. 3D is a schematic cross-sectional view of a battery fiber 350 having a plurality of formed batteries formed over a fibrous substrate, such as fibrous substrate 201. In one embodiment, the battery fiber 350 comprises a battery fiber 300, which is formed using the steps described above in conjunction with FIGS. 2, 3A-3C, 4 and 5, and a second battery fiber 351 that is formed over the battery fiber 300. In one embodiment, as shown in FIG. 3D, the battery fiber 300 and second battery fiber 351 are electrically connected in parallel so that the cathodic current collecting elements are in direct electrical contact (e.g., reference numeral 306). In this configuration, the outer most portion of the battery fiber 300 and the inner most portion of the second battery fiber 351 are each the cathodic portion, respectively, of the formed batteries. In this configuration, the cathode portion of the battery fiber 300 and the cathode portion of the second battery fiber 351 are adjacent to each other, or even share a common cathodic current collecting layer (e.g., reference number 306). In another embodiment, the cathode portion of the battery fiber 300 and the cathode portion of the second battery fiber 351 are isolated from each other by an insulating layer, such as the protective coating layer 308 (discussed above) that is disposed between the formed batteries 300, 351. The battery structure(s) shown in FIGS. 3A-3C and 3D each illustrate one anode and cathode configuration, and these configurations are not intended to be limiting as to the scope of the invention described herein, since the order in which the anodic and cathodic structures in the battery fiber 300 and/or the second battery fiber 351 could be reversed without deviating from the basic scope of the invention described herein.

In one embodiment, after the battery fiber 300 is formed using the steps described above in conjunction with FIGS. 2, 3A-3C, 4 and 5, the second battery fiber 351 is formed over the battery fiber 300 following the same process steps, but in reverse order. After the battery the second battery fiber 351 is formed over the battery fiber 300 the structure may be covered with a protective layer, such as a protective coating layer 308. The protective coating layer 308 may be deposited using wet or dry deposition methods which include but are not limited to sputtering, ion beam assisted sputtering, chemical vapor deposition, plasma enhanced chemical vapor deposition, atomic layer deposition, metal organic chemical vapor deposition, electrochemical deposition, and electroless deposition. Next, any of the layers in the formed battery fiber 350 may be patterned to allow electrical connections to be made to one or more of the formed layers found in the battery fiber 300 or the second battery fiber 351. The patterning steps may include various patterning and material removal techniques which are discussed above. Additional processing steps, such as cleaning steps or rinsing steps may also be performed before, during, or after any of the steps used to form the battery fiber 300 or the second battery fiber 351.

### Metallized Fiber Formation Apparatus Examples

The processes shown in FIGS. 4 and 5 and described herein for forming the metallized fiber 200 and the battery fiber 300 may be carried out using various apparatuses. FIG. 6A is a simplified schematic view of an apparatus for forming the metallized fiber 200 shown in FIG. 2 according to one embodiment of the invention. A processing apparatus 600 comprises a plurality of processing stations 601A, 601B, 601C, 601D, 601E, and 601F that contain the processing station apparatuses 603A, 603B, 603C, 603D, 603E, and 603F, respectively.

The processing apparatus 600 is adapted for processing a plurality of continuous fibrous substrates 201 of extended length to form metallized fibers 200. Although only three fibrous substrates 201 are shown, the processing apparatus 600 may be adapted to process any number of fibrous substrates 201. The processing stations 601A-601 F and processing station apparatuses 603A-603F are shown disposed in a linear configuration but non-linear configurations, such as polygonal or circular, for example, may be used for the processing apparatus 600. In one embodiment, the processing apparatus 600 comprises a manufacturing line.

The processing apparatus 600 also comprises one or more primary supports 604A (three are shown) disposed at various locations along each fibrous substrate 201 to provide support for the fibrous substrate 201. The primary support 604A may comprise a roller, wheel, spool, drum, supply reel, take-up reel or other means for supporting, guiding, stretching, or moving the fibrous substrates 201. In one embodiment, the primary support 604A comprises a roller or take-up reel which is coupled to the fibrous substrate 201. The primary support 604A may be adapted to rotate in a rotation direction 614 so that the fibrous substrate 201 may move in a motion direction 602 through the processing stations 601A-601F for processing of the fibrous substrate 201 along its length. One or more of the primary supports 604A disposed along the length of each fibrous substrate 201 may be coupled to a suitable actuator, such as an electric motor or other conventional actuator (not shown), which causes and controls the rotation and angular position of the primary support 604A.

The processing apparatus 600 and the one or more primary supports 604A may also be adapted to move the fibrous substrates 201 continuously, intermittently, or bi-directionally (e.g., opposite to motion direction 602) to position portions of the fibrous substrates 201 within the processing apparatus 600 so that a desired processing sequence can be performed on the fibrous substrate 201. In one embodiment, the processing apparatus 600 and the one or more primary supports 604A are adapted to move the fibrous substrates 201 at a speed (i.e. take-up speed) ranging from about 10 meters per minute to about 1,000 meters per minute.

Each of the processing stations 601A-F may be adapted for dry or wet processing of the fibrous substrates 201, and the processing may include but is not limited to fiber forming, graphitic nanofilament growth, material deposition, intercalation, annealing, etching, patterning, irradiating, anodizing, oxidizing, sensitizing, activating, cleaning, and rinsing. The methods of material deposition may include but are not limited to sputtering, ion beam assisted sputtering, chemical vapor deposition, plasma enhanced chemical vapor deposition, atomic layer deposition, metal-organic chemical vapor deposition, cathodic arc and laser ablation of carbon targets, electrochemical deposition, electroless deposition, and electrophoretic deposition. Each of the processing station apparatuses 603A-F comprise one or more apparatuses which are adapted for processing the fibrous substrates 201. The sequential processing of a continuous fibrous substrate 201 is described herein for a representative portion of the continuous substrate which moves from one station to the next for processing.

In one embodiment, the processing station 601A is adapted for forming the fibrous substrates 201 and the processing station apparatus 603A comprises a fiber forming device to which a fiber precursor material 620 is supplied. The fibrous substrates 201 emerge from the fiber forming device as a continuous fiber and are supported, guided, and moved through the processing stations 601B-F by the primary supports 604A. The processing station apparatus 603A may be adapted to use the fiber forming methods and fiber precursor materials 620 described herein (see FIG. 4, step 402).

In one embodiment, the processing station apparatus 603A comprises a fiber spinning apparatus, such as a positive displacement, piston-type extruder, for example. In one embodiment, the fiber forming apparatus is adapted for heating the fiber precursor materials 620. In one embodiment, the processing station apparatus 603A comprises one or more extrusion holes 641 (three are shown; each hole is represented by a dot) through which fiber precursor materials 620 may be extruded to form the fibrous substrates 201. In one example, the processing station apparatus 603A comprises one to one hundred extrusion holes 641. In one embodiment, each extrusion hole 641 has a diameter ranging from about 1 nanometer to about 100 nanometers. In another embodiment, each extrusion hole 641 has a diameter ranging from about 1 nanometer to about 1,000 micrometers. Each extrusion hole 641 may also have a high length-to-diameter aspect ratio. Each extrusion hole 641 may have a cross-sectional shape which includes but is not limited to round, oval, square, rectangular, hexagonal, pentagonal, octagonal, lobed, or tri-lobed. The cross-sectional shape of the extrusion hole 641 allows formation of a fibrous substrate 201 having the same cross-sectional shape. The processing station apparatus 603A may also include apparatuses (not shown) for processing the fibers following extrusion, and such apparatuses may include baths or heating elements, for example.

The fibrous substrates 201 move in the motion direction 602 to the next processing station 601B. In one embodiment, the processing station 601B is adapted for preparing the fibrous substrates 201 for graphitic nanofilament growth. The preparation processing may include but is not limited to the types of processing described herein for preparing substrates for graphitic nanofilament growth. Examples of such processing may include but are not limited to depositing catalyst materials and/or supplementary materials on the fibrous substrates 201 and patterning the materials thereon using masking, etching, selective deposition or wetting, or other patterning techniques. In one embodiment, the processing station 601B is adapted for forming supplementary layers 203 on the fibrous substrates 201. In one embodiment, the processing station 601B is adapted for dry processing and the processing station apparatus 603B comprises a sputter deposition apparatus or a CVD deposition apparatus.

The next station for processing of the fibrous substrates 201 is the processing station 601C. In one embodiment, the processing station 601C is adapted for forming graphitic nanofilaments on the fibrous substrates 201. The processing station 601C may be adapted to use any of the catalytic or non-catalytic CVD methods described herein for forming graphitic nanofilaments. The processing station apparatus 603C may comprise CVD deposition apparatuses known in the art and which include but are not limited to tube reactors (e.g., tube furnaces), showerhead reactors, linear injection reactors, hot-filament reactors, high pressure reactors, plasma reactors, and high-density plasma reactors. The processing station apparatus 603C may also be adapted for aligning the graphitic nanofilaments on the surfaces of the fibrous substrates 201. For example, the processing station apparatus 603C may be adapted for applying an electric field in proximity to the graphitic nanofilaments, for example. The electric field may be produced by a plasma forming apparatus or another type of electric field generating apparatus. The processing station 601C may also be adapted for intercalating the graphitic nanofilaments. In another embodiment, the metallized fiber 200 does not include the nanofilament layer 204 and the processing station 601C is omitted from the processing apparatus 600.

Next, after processing at the processing station 601C, the fibrous substrates 201 move to the processing station 601D. In one embodiment, the processing station 601D is adapted for forming initiation-adhesion layers 206 on the fibrous substrates 201. In one embodiment, the processing station 601D is adapted for wet processing of the fibrous substrates 201 and the processing station apparatus 603D comprises one or more apparatuses adapted for contacting the fibrous substrates 201 and material layers thereon with one or more liquids for processing. In one embodiment, the processing station apparatus 603D comprises one or more apparatuses adapted for depositing materials using deposition methods which may include but are not limited to electrochemical deposition, electroless deposition, and electrophoretic deposition. In another embodiment, the processing station 601D is adapted for dry processing of the fibrous substrates 201 and the processing station apparatus 603D comprises one or more apparatuses adapted for depositing nucleation or seed layers onto the fibrous substrates 201. In one embodiment, the processing station apparatus 603D comprises a sputter deposition apparatus or a CVD deposition apparatus.

The next station for processing is processing station 601E which, in one embodiment, is adapted for forming metallic layers 208 on the initiation-adhesion layers 206 formed on the fibrous substrates 201. In one embodiment, the processing station 601E is adapted for wet processing and the processing station apparatus 603E comprises one or more apparatuses adapted for depositing metallic materials using deposition methods which may include but are not limited to electrochemical deposition, electroless deposition, and electrophoretic deposition.

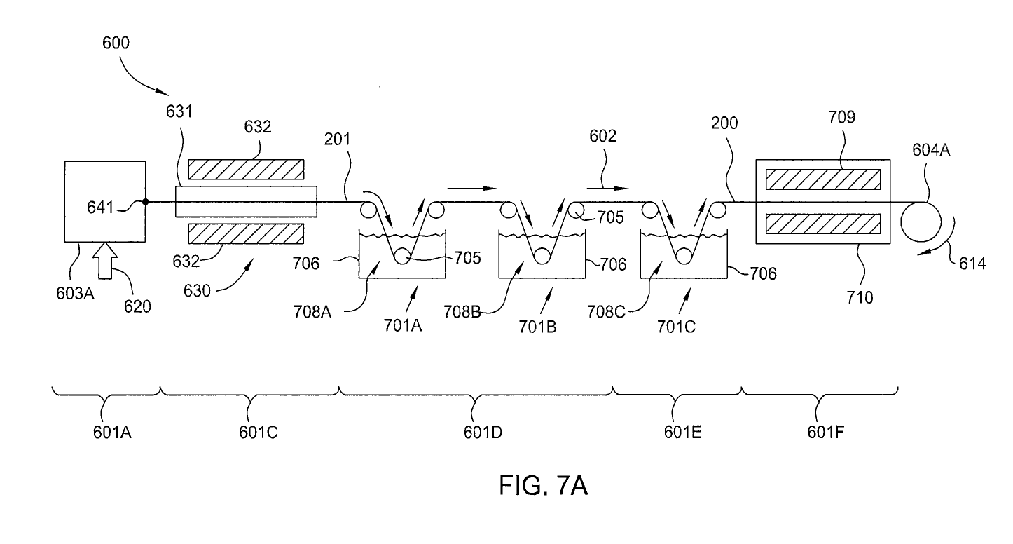

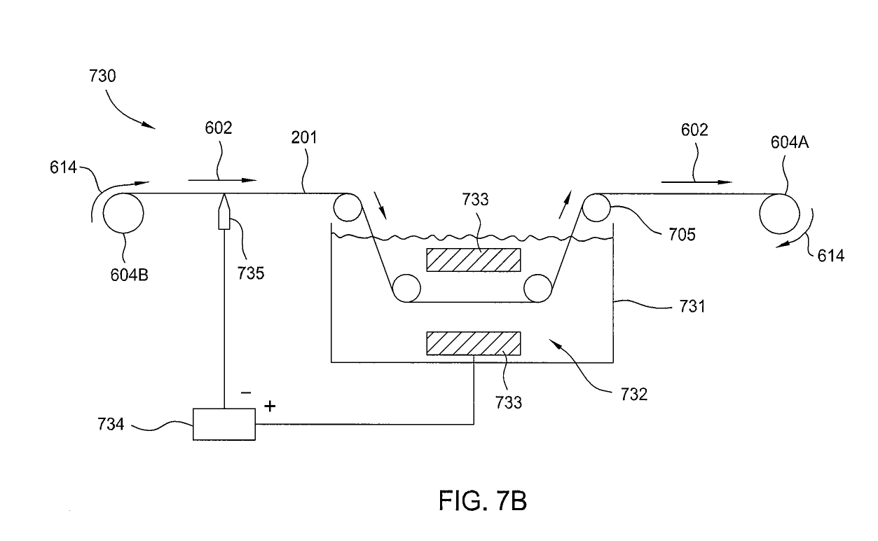

Metallized fibers 200 leave the processing station 601E and may then pass through another processing station 601F to complete the processing of the metallized fibers 200. In one embodiment, the processing station 601F is adapted for annealing the metallized fibers 200, and the processing station apparatus 603F comprises one or more elements (see FIG. 7A) for heating the metallized fibers 200. The processing station 601F may be adapted to use the annealing methods, apparatus, and processing parameters described herein for annealing the metallic layer 208.

The metallized fibers 200 may be wound up onto take-up reels and stored for later use or processing after undergoing processing at the processing station 601F. Alternately, the metallized fibers 200 may move through additional stations for processing after being processed at the processing station 601F.

FIG. 6B is a simplified detail view of the apparatus shown in FIG. 6A according to another embodiment described herein. The processing station 600 may comprise one or more connecting enclosures 625 (three are shown between station pairs) which are disposed between pairs of the processing station apparatuses 603A-C for the processing stations 601A-C. Each connecting enclosure 625 extends between pairs of the processing station apparatuses 603A-C and encloses the fibrous substrate 201. In another embodiment, each connecting enclosure 625 may enclose a plurality of fibrous substrates 201. The connecting enclosure 625 may be adapted to prevent or reduce contamination of the fibrous substrate 201 as it moves between the processing stations 601A-C.

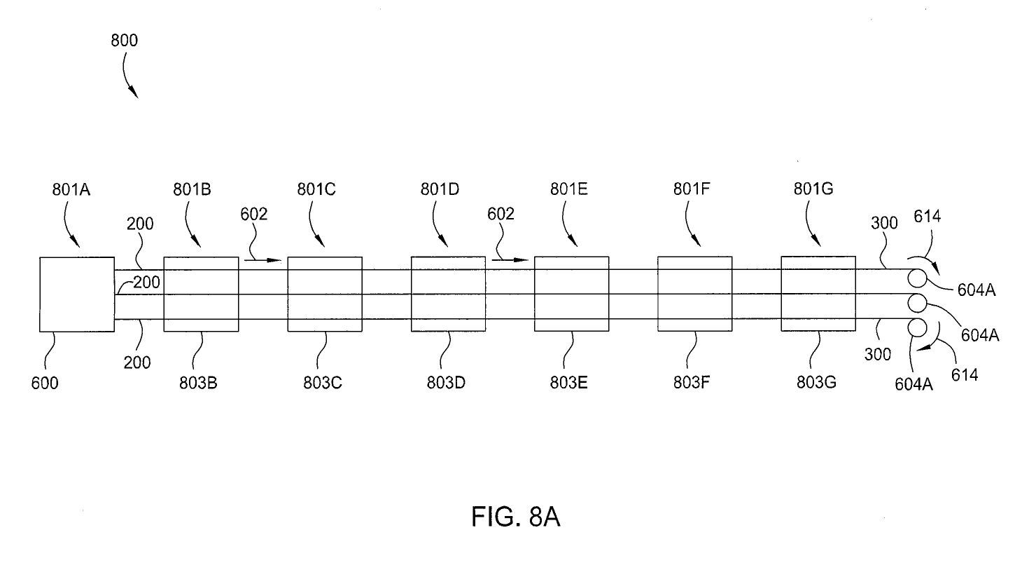

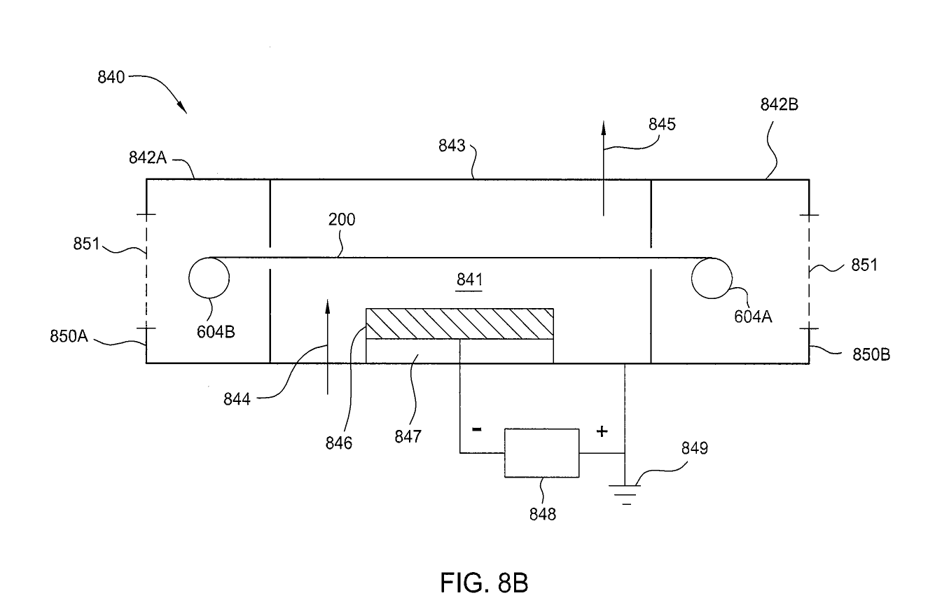

The connecting enclosure 625 may comprise a tube or other hollow structure which can enclose one or more fibrous substrates 201. The connecting enclosure 625 may comprise ceramic, quartz, glass, silica, aluminum oxide, metal, metal alloy, or other materials. In one embodiment, the connecting enclosure 625 is adapted to withstand high temperatures and large pressure differentials across the enclosure walls. In one embodiment, the connecting enclosure 625 comprises a quartz tube. In another embodiment, the connecting enclosure 625 comprises a buffer chamber (see FIG. 8B).

The connecting enclosures 625 may be coupled to the processing station apparatuses 603A-C so that fluid seals (not shown) are formed where the connecting enclosures 625 and processing station apparatuses 603A-C are coupled. The fluid seals may be adapted to isolate fluids inside the connecting enclosures 625 from fluids outside of the connecting enclosures 625. In one embodiment, the fluid seals comprise vacuum seals. In one embodiment, one or more connecting enclosures 625 extend through (see dotted lines 626) the processing station 601C. The processing apparatus 600 may comprise connecting enclosures 625 which extend between and through any of the processing stations 601A-F.

FIG. 6C is a simplified schematic view of the apparatus shown in FIG. 6A according to another embodiment described herein. The processing station 601B has been omitted from the processing apparatus 600 and the processing station 601C comprises one or more (three are shown) tube furnaces 630 for forming graphitic nanofilaments on the fibrous substrates 201. A single fibrous substrate 201 is shown passing through each tube furnace 630, but each tube furnace 630 may be adapted for receiving and processing more than one fibrous substrate 201. The tube furnace 630 comprises a deposition apparatus commonly used for growing graphitic nanofilaments. Each tube furnace 630 comprises a reactor tube 631 and heating elements 632 (e.g., resistive heaters, induction coils, lamps) which are disposed about the reactor tube 631. In one embodiment, the processing station 601C comprises a plurality of tube furnaces 630 and reactor tubes 631. In one embodiment, the number of reactor tubes 631 ranges from one to one hundred. In one embodiment, the reactor tubes 631 comprise connecting enclosures 625 which extend to the processing station 601A and couple to the processing station apparatus 603A. The reactor tube 631 may comprise a refractory material to withstand high temperatures. In one embodiment, the reactor tube 631 comprises a quartz tube. The tube furnace 630 may be adapted for catalytic or non-catalytic growth of graphitic nanofilaments. The tube furnace 630 may also be adapted for plasma enhanced CVD processing which may facilitate graphitic nanofilament growth and alignment. The heating elements 632 heat the reactor tubes 631 and a nanofilament process gas 640 is injected into the reactor tubes 631 in proximity to the heating elements 632. The nanofilament process gas 640 may comprise carbon source gases, carrier gases, reducing gases, and other gases described herein for growing graphitic nanofilaments. For catalytic growth processes, the nanofilament process gas 640 may also include catalyst materials or catalyst precursors. The nanofilament process gas 640, including the carbon source gas, flow through the reactor tubes 631 and over the fibrous substrates 201 to form graphitic nanofilaments on the fibrous substrates 201.

FIG. 6D is a simplified schematic view of the apparatus shown in FIG. 6A according to one embodiment described herein. The processing station 601C is omitted from the processing apparatus 600 and the processes of forming fibers and graphitic nanofilaments are combined in the processing station 601A. The processing station apparatus 603A is adapted for integrating the formation of fibers and graphitic nanofilaments into a single operation. Fiber precursor material 620 and nanofilament process gas 640 are supplied to the processing station apparatus 603A and fibrous substrates 201 having nanofilament layers 204 are formed, thereby eliminating the need for a separate station which forms graphitic nanofilaments.

FIG. 6E is a simplified schematic view of the apparatus shown in FIG. 6A according to another embodiment described herein. The processing apparatus 600 does not include the processing station 601A or any apparatus for fiber formation. The processing station 601A is replaced by one or more primary supports 604B (three are shown) which comprise supply reels containing the fibrous substrates 201. The fibrous substrates 201 may be formed in a separate operation or may comprise commercially available fibers. In another embodiment, the primary supports 604B are identical in form and function to primary supports 604A.

FIG. 7A is a simplified schematic view of the apparatus shown in FIG. 6A which uses a wet deposition process according to another embodiment of the invention. The processing apparatus 600 comprises the processing stations 601A, 601C, 601D, 601E, and 601F. In another embodiment, the processing apparatus 600 may include the processing station 601B for forming supplementary layers and/or preparing the fibrous substrate 201 for graphitic nanofilament growth. For clarity, a single fibrous substrate 201 is shown but the fibrous substrate 201 may represent a plurality of fibrous substrates 201. The processing apparatus 600 also comprises at least one primary support 604A and secondary supports 705 for moving one or more fibrous substrates 201 through the processing apparatus 600 in the motion direction 602. The secondary supports 705 comprise rollers, wheels, spools, or other suitable means for supporting and guiding one or more fibrous substrates 201.

The processing station 601A comprises the processing station apparatus 603A which is adapted for forming one or more fibrous substrates 201. The processing station 601C comprises one or more tube furnaces 630 for growing graphitic nanofilaments to form the nanofilament layer 204. In one embodiment, the processing station 601C comprises a plurality of tube furnaces 630 (see FIG. 6C) and each tube furnace 630 may be adapted for processing one or more fibrous substrates 201. In another embodiment, the processing station 601C is omitted from the processing apparatus 600 and graphitic nanofilaments are not formed on the fibrous substrate 201.

After processing at the processing station 601C, the fibrous substrate 201 moves to the processing station 601D which is adapted for forming the initiation-adhesion layer 206 on the fibrous substrate 201. The fibrous substrate 201 then moves to the processing station 601E which is adapted for forming the metallic layer 208 on the initiation-adhesion layer 206. The processing station 601D comprises processing stations 701A-B and the processing station 601E comprises a processing station 701C. The processing stations 701A-C are adapted for wet processing of the fibrous substrate 201. Although only three processing stations 701A-C are shown, each of the processing stations 601D-E may comprise any number of stations for wet processing.

The processing stations 701A-C are adapted to contain liquids for substrate processing. The processing stations 701A-C include processing liquids 708A-C, respectively, and the liquids are contained within processing tanks 706. Each processing tank 706 comprises any suitable container for containing the required amount and type of liquid needed for processing. The processing stations 701A-C may be adapted to perform various types of processing which include but are not limited to depositing metals, depositing supplementary materials, activating, sensitizing, rinsing, cleaning, and intercalating graphitic nanofilaments. The processing liquids 708A-C may comprise electroless plating solutions, electrochemical plating solutions, sensitizing solutions, activating solutions, electrophoretic deposition solutions, intercalation solutions, supplementary material solutions, pre-treatment solutions, rinsing solutions, cleaning solutions, slurries, or other types of solutions and combinations thereof for processing the fibrous substrate 201.

In one embodiment, the processing stations 701A-C are adapted for electroless deposition. The fibrous substrate 201 moves to the processing station 701A and passes through the processing liquid 708A which comprises a sensitizing solution. The fibrous substrate 201 then moves to the processing station 701B and passes through the processing liquid 708B which comprises an activating solution. The processing liquids 708A-B form the initiation-adhesion layer 206 on the fibrous substrate 201. Next, the fibrous substrate 201 moves to the processing station 701C which contains the processing liquid 708C which comprises an electroless plating solution which deposits metal over the initiation-adhesion layer 206 to form the metallic layer 208. In another embodiment, one or more of the processing stations 701A-C may be adapted for electrochemical plating (see FIG. 7B).

The fibrous substrate 201 is metallized at the processing station 601E to form the metallized fiber 200 which then moves to the processing station 601F. The processing station 601F is adapted for annealing the metallized fiber 200, and the processing station 601F comprises one or more heating elements 709 (e.g., resistive heaters, lamps) for heating the metallized fiber 200. In one embodiment, the processing station 601F comprises an annealing chamber 710 which contains the heating elements 709. The annealing chamber 710 may allow the annealing to be performed under controlled pressures (e.g., vacuum) and within controlled gas environments (e.g., inert gases).

It is to be understood that the processing apparatus 600 may comprise additional stations and solutions for processing to enable various processing sequences. For example, the fibrous substrate 201 may pass through a cleaning solution before reaching the processing station 701A and then may pass through rinsing solutions after each of the processing stations 701A-C, where the cleaning and rinsing may be similarly configured like the processing stations 701A-C. Additionally, each of the processing stations 601A-F may be adapted to utilize both wet and dry processing techniques for processing the fibrous substrate 201.

FIG. 7B is a simplified schematic view of a wet deposition apparatus according to one embodiment described herein. A processing station 730 adapted for electrochemical plating comprises a tank 731 filled with an electrolyte plating solution 732. One or more anodes 733 are disposed in the electrolyte plating solution 732. The one or more anodes 733 comprise a desired plating metal and each anode 733 is suitably shaped and disposed about the fibrous substrate 201 to facilitate depositing metal onto one or more surfaces of the fibrous substrate 201. The processing station 730 may also comprise primary supports 604A-B and one or more secondary supports 705 which position and guide the fibrous substrate 201 as it moves through the electrolyte plating solution 732 near the one or more anodes 733. The secondary supports 705 may comprise a suitable material (e.g., electrically non-conducting) to prevent plating onto the secondary supports 705 which are exposed to the electrolyte plating solution 732.

To perform an electrochemical process on the fibrous substrate 201 one or more of its surfaces, or plating surfaces, needs to be electrically conductive. Each plating surface may comprise a metal seed layer which is deposited onto the host substrate 300 before electrochemical plating as discussed above in relation to FIGS. 2-6. The processing station 730 further comprises a power supply 734 (e.g., direct current) and a contact brush 735 or other suitable means which provides electrical contact with the one or more plating surfaces of the fibrous substrate 201 as it moves in the motion direction 602. The power supply 734 is connected with the polarity shown to the one or more anodes 733 and the one or more conductive plating surfaces (i.e., cathodes) of the fibrous substrate 201. The power supply 734 provides a plating current which deposits metal onto the plating surfaces of the fibrous substrate 201 as it moves through the electrolyte plating solution 732.

In another embodiment, the processing station 730 is adapted for the electrophoretic deposition of metals or supplementary materials. The electrolyte plating solution 732 is replaced with an electrophoretic deposition solution which contains the desired metal or supplementary material to be deposited. The one or more anodes 733 may be replaced with counter-electrodes so that material may be deposited on the primary electrode which comprises the plating surfaces of the host substrate 300. Alternately, an electrically conductive tank 731 may function as the counter electrode. The power supply 734 polarity as shown in FIG. 7B may be used for cathodic electrophoretic deposition. The polarity may be reversed for anodic electrophoretic deposition.

### Battery Fiber Formation Apparatus Examples

The metallized fiber 200 formed by the processing apparatus 600 may be further processed to form the battery fiber 300 using an apparatus of the present invention. FIG. 8A is a simplified schematic view of an apparatus for forming the battery fiber 300 shown in FIGS. 3A and 3B according to one embodiment of the invention. A processing apparatus 800 comprises a plurality of processing stations 801B, 801C, 801D, 801E, 801F, and 801G which comprise processing station apparatuses 803B, 803C, 803D, 803E, 803F, and 803G respectively, although the processing apparatus 800 may comprise any number of stations and apparatuses for processing. The processing apparatus 800 also comprises a processing station 801A which comprises the processing apparatus 600.

The processing apparatus 800 is adapted for processing a plurality of continuous metallized fibers 200 of extended length to form battery fibers 300. Although only three metallized fibers 200 are shown, the processing apparatus 800 may be adapted to process any number of metallized fibers 200. The processing stations 801A-801G may be disposed in a linear configuration (as shown) or in a non-linear configuration, such as a circular or polygonal configuration, for example. The processing apparatus 800 also comprises one or more primary supports 604A (three are shown) which may be disposed at various locations along each metallized fiber 200 to support, guide, and move each metallized fiber 200 through the processing apparatus 800. The processing apparatus 800 and the one or more primary supports 604A may also be adapted to move the metallized fibers 200 continuously, intermittently, or bi-directionally to facilitate depositing, treating, or patterning the material layers on portions of the metallized fibers 200. In one embodiment, the processing apparatus 800 and the one or more primary supports 604A are adapted to move the fibrous substrates 201 at a speed (i.e. take-up speed) ranging from about 10 meters per minute to about 1,000 meters per minute. The processing apparatus 800 may also comprise one or more connecting enclosures 625 (see FIG. 6B) which may be disposed between any pair of the processing station apparatuses 803B-G and processing apparatus 600.

Each of the processing stations 801B-G may be adapted for dry or wet processing of the metallized fiber 200, and the processing may include but is not limited to material deposition, annealing, etching, patterning, irradiating, anodizing, oxidizing, sensitizing, activating, cleaning, and rinsing. The methods of material deposition may include but are not limited to sputtering, ion beam assisted sputtering, magnetron sputtering, thermal evaporation, ion beam evaporation, chemical vapor deposition, plasma enhanced chemical vapor deposition, atomic layer deposition, metal-organic chemical vapor deposition, cathodic arc evaporation, electrochemical deposition, electroless deposition, and electrophoretic deposition. Each of the processing station apparatuses 803B-G comprise one or more apparatuses which are adapted for processing the metallized fiber 200.

The processing station 801A is adapted for forming the metallized fiber 200 and comprises the processing station apparatus 600. In another embodiment, the metallized fibers 200 may be formed in a separate operation and the processing station 801A may be replaced with one or more primary supports 604B (see FIG. 6E) which comprise supply reels containing the metallized fibers 200.

The metallized fibers 200 move to the processing station 801B for processing of the metalized fibers 200 received from processing station 801A. In one embodiment, the processing station 801B is adapted for depositing anodic materials onto the metallized fibers 200 to form the anode layer 309. The processing station 801B may also be adapted for preparing the metallized fibers 200 for material deposition, and methods of preparation may include cleaning, rinsing, or etching, for example. In one embodiment, the processing station 801B is adapted for dry processing and the processing station apparatus 803B comprises a sputter deposition apparatus, a CVD deposition apparatus, and/or an etching apparatus. In another embodiment, the processing station 801B is adapted for wet processing and the processing station apparatus 803B is adapted for contacting the metallized fibers 200 with one or more liquids for processing, and the liquids may comprise one or more of the processing liquids 708A-C described herein.

The next station for processing of the metallized fibers 200 is the processing station 801C. In one embodiment, the processing station 801C is adapted for depositing electrolytic materials to form the electrolyte/separator layer 302. The processing station apparatus 803C may be adapted for wet or dry deposition. In one embodiment, the processing station apparatus 803C comprises a sputter deposition apparatus or a CVD deposition apparatus.

Next, the metallized fibers 200 move to the processing station 801D. In one embodiment, the processing station 801D is adapted for forming the cathode layer 304 on the metallized fibers 200. In one embodiment, the processing station apparatus 803D comprises a sputter deposition apparatus or a CVD deposition apparatus.

Next, after depositing the cathode layer 304, the metallized fibers 200 move to the processing station 801E. In one embodiment, the processing station 801E is adapted for depositing the second metallic layer 306 onto the metallized fibers 200. In one embodiment, the second metallic layer 306 is deposited using a wet deposition method and the processing station apparatus 803E is adapted for contacting the metallized fibers 200 with one or more liquids for processing, and the liquids may comprise one or more of the processing liquids 708A-C described herein. In one embodiment, the processing station apparatus 803E comprises one or more apparatuses adapted for electrochemical deposition, electroless deposition, or electrophoretic deposition. The processing station apparatus 803E may also be adapted to deposit a seed or initiation layer and a bulk metal layer. In another embodiment, the processing station apparatus 803E comprises a dry deposition apparatus, such as a sputter deposition apparatus or a CVD deposition apparatus, for example. In yet another embodiment, the processing station apparatus 803E comprises both wet and dry deposition apparatuses.

In one embodiment, the processing at processing station 801E completes the formation of the essential layers of the battery fibers 300 prior to charging of the battery fibers 300. Some additional processing steps, such as annealing or forming protective layers, for example, may be added to complete processing of the battery fibers 300.

The next station for processing is the processing station 801F. In one embodiment, the processing station 801F is adapted for annealing the battery fibers 300. The processing station apparatus 803F is adapted to anneal the second metallic layer 306 and/or other materials in the battery fibers 300. The processing station apparatus 803F may comprise an annealing chamber 710 (FIG. 7A) or other types of apparatuses for heating the battery fibers 300. The annealing methods and parameters described herein for annealing the metallic layer 208 may be used for annealing the second metallic layer 306. In another embodiment, additional stations for annealing or heating may be disposed after any of the processing stations 801A-G.

Next, the battery fibers 300 move to the processing station 801G. In one embodiment, the processing station 801G is adapted for forming the protective coating layer 308 on the battery fibers 300. The processing station apparatus 803G may be adapted for wet or dry deposition. In one embodiment, the processing station apparatus 803G is adapted for contacting the battery fibers 300 with one or more liquids for processing, and one or more of the liquids may comprise melts of various materials. In another embodiment, the processing station 801G is adapted for annealing and the processing station 801F is adapted for forming the protective coating layer 308 on the battery fibers 300.

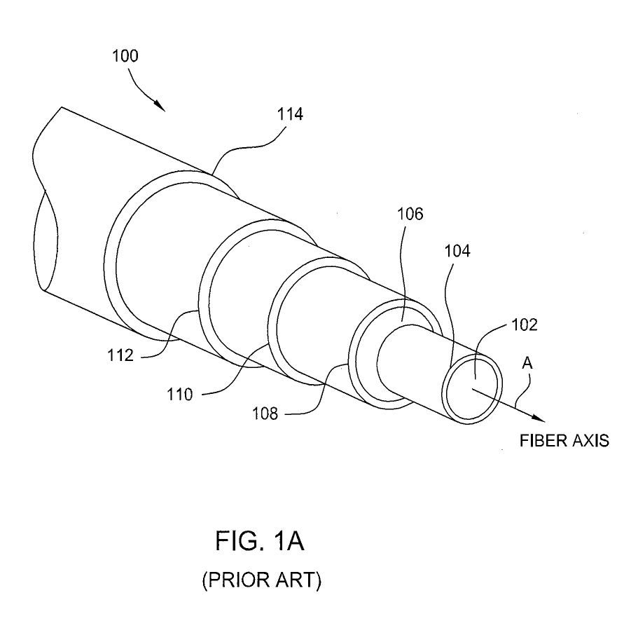

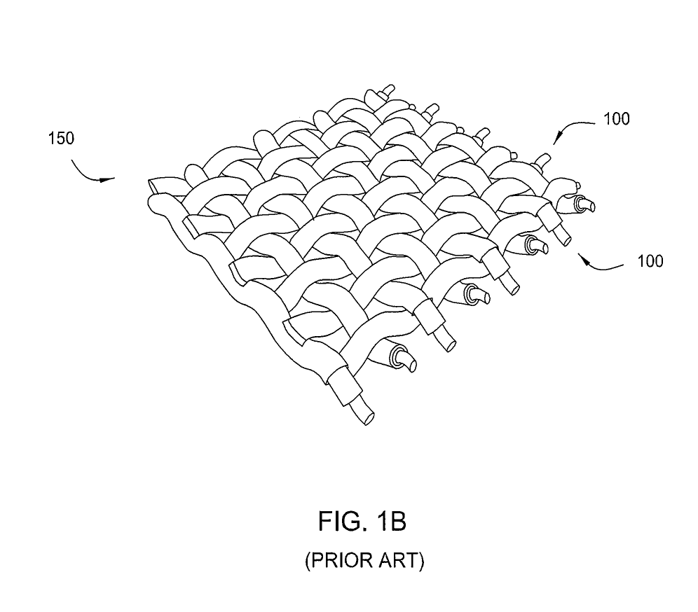

After processing at the processing station 801G, the battery fibers 300 may be wound up onto take-up reels (e.g., primary supports 604A) and stored for later charging or additional processing. The additional processing may include using the battery fibers 300 to form various types of fiber composite materials (e.g., fabrics, fiber-reinforced sheets, tubes, or other structures) and then charging the battery fibers 300. In one embodiment, the battery fibers 300 are used to form the battery fiber fabric 150 (FIG. 1B).

The processing station apparatuses 803B-G shown in FIG. 8A and described herein may include a sputtering apparatus which is adapted for depositing materials on fibers.

FIG. 8B is a simplified schematic view of a deposition apparatus according to one embodiment of the invention. A processing station 840 for sputter depositing various materials onto the metallized fiber 200 comprises a process chamber 843 and buffer chambers 842A-B. The buffer chambers 842A-B contain primary supports 604A-B for supporting and moving a continuous metallized fiber 200 through a processing region 841. One or more of the buffer chambers 842A-B may be suitably adapted to allow transfer of the metallized fiber 200 from the one of the buffer chambers 842A-B to another chamber or station for processing. In one embodiment, each of the buffer chambers 842A-B comprise a sealable port 851 (see dotted line) which allows the coupling of the processing station 840 with another processing chamber or station. In one embodiment, two or more processing stations 840 are coupled together by coupling a chamber side 850A of buffer chamber 842A of a first processing station 840 to a chamber side 850B of buffer chamber 842B of a second processing station 840 and the sealable ports 851 are opened so that the metallized fiber 200 may move through each processing station 840 for processing. In one embodiment, one or more of the processing stations 601A-F, 801B-G shown in FIGS. 6A and 8A comprise one or more processing stations 840 which may be coupled together within a station or between stations. The sealable ports 851 may comprise vacuum seals so that the metallized fiber 200 may move between processing stations processing station 801A-G under vacuum.

The process chamber 843 and buffer chambers 842A-B may be coupled to and in fluid communication with a vacuum pumping system (not shown) to remove exhaust gases 845 and allow adjustment of the pressure in the process chamber 843 and in the buffer chambers 842A-B. The process chamber 843 may operate at vacuum or near-atmospheric pressures, and the buffer chambers 842A-B may operate at pressures higher than the pressure in the process chamber 843.

The process chamber 843 also includes a target 846 coupled to an insulative source block 847 which may comprise a magnetron and a heat exchanger or other cooling means. The target 846 is electrically isolated from the process chamber 843 and is electrically connected to a power supply 848. The other terminal of the power supply 848 may be connected to the process chamber 843 and a ground 849 with the polarity shown. The power supply 848 is a DC power supply (as shown) which may be used to sputter electrically conductive materials. In another embodiment, the power supply 848 is an alternating power supply (e.g., radio frequency generator) which may be used to sputter electrically insulative materials. In another embodiment, the power supply 848 is connected to the target 846 and another suitable counter-electrode within the process chamber 843.

The target 846 comprises a desired deposition material, such as a metal or metal alloy, for example. A process gas 844 is introduced into the process chamber 843 and a plasma is formed in the processing region 841. Material is sputtered from the target 846 and deposited onto metallized fiber 200. The metallized fiber 200 may move during sputter deposition so that material is deposited along the length of the continuous metallized fiber 200. The processing station 840 may be suitably adapted so that material may be deposited onto one or more sides of the metallized fiber 200. For example, the metallized fiber 200 may be rotated during deposition, or more than one target 846 may be disposed about the metallized fiber 200, or one target 846 may move about the metallized fiber 200. The processing station 840 may also be adapted for reactive sputtering.

As describe herein, the metallized fibers 200 and battery fibers 300 are formed on continuous fibrous substrates 201 having extended length. In another embodiment, the fibrous substrates 201 may be discrete and have limited length, and the apparatuses 600, 800 may be adapted for processing discrete fibrous substrates 201. For example, the primary supports 604A-B may comprise fixtures adapted to hold one or more discrete fibrous substrates 201 and the fixtures may be adapted to move through and between the processing stations 601A-F, 801A-G to process the discrete fibrous substrates 201. In another embodiment, the apparatuses 600, 800 may comprise one or more cluster tools having the processing stations 601A-F, 801A-G which are adapted for processing discrete fibrous substrates 201 on a cluster tool, and the discrete fibrous substrates 201 may be supported by fixtures which may be transferred between the stations by fixture-handling robots on the cluster tool(s).

While the foregoing is directed to embodiments of the present invention, other and further embodiments of the invention may be devised without departing from the basic scope thereof, and the scope thereof is determined by the claims that follow.

1. A battery fiber, comprising:
a metallized fiber, comprising:
a fibrous substrate;
an initiation-adhesion layer disposed over the fibrous substrate; and
a first metallic layer disposed on the initiation-adhesion layer;
an electrolyte layer disposed over the first metallic layer;
a cathode layer disposed on the electrolyte layer; and
a second metallic layer disposed on the cathode layer.

2. The battery fiber of claim 1, further comprising an anode layer disposed on the first metallic layer, wherein the anode layer is formed using a wet deposition process.

3. The battery fiber of claim 2, further comprising a protective coating layer disposed on the second metallic layer.

4. The battery fiber of claim 1, further comprising a nanofilament layer comprising graphitic nanofilaments, wherein the nanofilament layer is formed on a surface of the fibrous substrate, and the initiation-adhesion layer is formed over the nanofilament layer.

5. The battery fiber of claim 1, wherein the first metallic layer comprises copper or a copper alloy.

6. The battery fiber of claim 2, wherein the anode layer comprises one or more materials selected from a group consisting of lithium, alkali metals, alkaline earth metals, transition metals, carbon, graphite, sodium, sodium-lead alloys, tin nitrides, lithium nitrides, lithium-aluminum alloys, lithium-bismuth alloys, lithium-cadmium alloys, lithium-magnesium alloys, lithium-lead alloys, lithium-antimony alloys, lithium-tin alloys, lithium-zinc alloys, copper-tin alloys, iron-tin alloys, nickel-tin alloys, tin-antimony alloys, cobalt-tin-copper alloys, lithium-silicon alloys, tungsten oxide based alloys, and metal alloys containing alkali metals, alkaline earth metals, and/or transition metals.

7. The battery fiber of claim 6, wherein the anode layer comprises lithium, the electrolyte layer comprises lithium phosphorous oxynitride (LiPON), the cathode layer comprises lithium cobalt oxides (LiCoO) or lithium manganese oxides (LiMnO), and the second metallic layer comprises one or more materials selected from a group consisting of tin (Sn), palladium (Pd), nickel (Ni), copper (Cu), chromium (Cr), and aminopropyltriethoxysilane (APTS).

8. The battery fiber of claim 1, wherein the fibrous substrate comprises one or more materials selected from a group consisting of carbon, carbon-containing compounds, carbides, carbon nanotubes, carbon nanofibers, silicas, aluminum oxides, lead zirconium titanate, glasses, ceramics, polymers, aramids, aromatic polyamides, polyethylene, polyamides, nylons, acrylics, rayons, cellulosics, metals, metal alloys, semiconductors, superconductors, optical fibers, and wires.

9. A method of forming a battery fiber, comprising:
forming a metallized fiber, wherein forming the metallized fiber further comprises:
providing a fibrous substrate;
forming an initiation-adhesion layer over the fibrous substrate; and
depositing a first metallic layer on the initiation-adhesion layer,
wherein the first metallic layer is deposited using a wet deposition process;
depositing an electrolyte layer over the first metallic layer;
depositing a cathode layer on the electrolyte layer; and
depositing a second metallic layer on the cathode layer.

10. The method of claim 9, further comprising depositing an anode layer on the first metallic layer.

11. The method of claim 9, further comprising forming a protective coating layer on the second metallic layer.

12. The method of claim 9, further comprising forming a nanofilament layer comprising graphitic nanofilaments on the fibrous substrate, wherein the layer is formed using chemical vapor deposition, and wherein the initiation-adhesion layer is formed over the nanofilament layer.

13. The method of claim 10, wherein the anode layer is formed on the first metallic layer after depositing the electrolyte layer.

14. The method of claim 13, wherein the anode layer is formed by in-situ activation during charging of the battery fiber.

15. The method of claim 13, wherein the anode layer is formed by contacting the electrolyte layer with an electrolyte solution during an electrochemical deposition process.

16. The method of claim 10, wherein the anode layer is deposited on the anode layer before depositing the electrolyte layer.

17. The method of claim 9, wherein the anode layer or the second metallic layer is deposited using electroless deposition or electrochemical deposition.

18. The method of claim 9, wherein the depositing of the second metallic layer further comprises patterning the second metallic layer so that the layer is permeable to oxygen.

19. An apparatus for forming a metallized fiber, comprising:
a primary support adapted receive a portion of a fibrous substrate;
a fiber providing apparatus adapted for providing a fibrous substrate;
one or more processing stations disposed between the primary support and the fiber providing apparatus and adapted for metallizing a portion of the fibrous substrate; and
an actuator coupled to the primary support that is adapted to position a portion of the fibrous substrate in the one or more processing stations.

20. The apparatus of claim 19, further comprising an annealing station that is adapted to receive a portion of the fibrous substrate positioned between the primary support and the fiber providing apparatus.

21. The apparatus of claim 19, further comprising a nanofilament growth apparatus adapted for growing graphitic nanofilaments on a portion of the fibrous substrate disposed between the primary support and the fiber providing apparatus.

22. The apparatus of claim 19, further comprising at least one secondary support, wherein each said support is adapted to move and guide the fibrous substrate through the apparatus.

23. The apparatus of claim 19, wherein the fiber providing apparatus comprises:
a fiber forming apparatus adapted for forming a fiber using a fiber forming method selected from a group consisting of wet spinning, dry spinning, melt spinning, dry-wet spinning, gel spinning, sol-gel spinning, dry jet wet spinning, coagulation spinning, fiber drawing, and sol-gel fiber drawing; and
a nanofilament growth apparatus adapted for growing graphitic nanofilaments on a portion of the fibrous substrate.

24. The apparatus of claim 19, further comprising one or more connecting enclosures, each said enclosure coupled to two processing stations, wherein at least one connecting enclosure comprises a tube.

25. The apparatus of claim 19, wherein at least one of the one or more processing stations is adapted for electroless deposition or electrochemical deposition.
